(19) United States
(12) Patent Application Publication
(10) Pub. No.: US 2018/0337923 A1
(43) Pub. Date: Nov. 22, 2018

(54) AUTHENTICATION METHOD AND AUTHENTICATION SYSTEM

(71) Applicant: Renesas Electronics Corporation, Tokyo (JP)

(72) Inventors: Tadaaki TANIMOTO, Tokyo (JP); Daisuke MORIYAMA, Tokyo (JP)

(73) Assignee: Renesas Electronics Corporation, Tokyo (JP)

(21) Appl. No.: 15/944,022

(22) Filed: Apr. 3, 2018

(30) Foreign Application Priority Data
May 22, 2017 (JP) 2017-100845

(51) Int. Cl. H04L 29/06; B60R 25/24; H04L 9/08

(52) U.S. Cl. CPC H04L 63/0884; B60R 25/24; B60R 2325/108; H04L 9/0863; H04L 9/0869; H04L 63/0876

(57) ABSTRACT

In an authentication method according to an embodiment, a server generates first authentication information configured by a value generated by using a pseudo ransom function using an identifier of an authentication target device and a common key as arguments and transmits the first authentication information to the authentication target device via an authentication proxy client. The authentication target device checks validity of the first authentication information by comparing the value generated by using the pseudo random function using the identifier and the common key as arguments and the first authentication information, after checking the validity of the first authentication information, generates second authentication information configured by a value generated by using a pseudo random function using the identifier of the authentication target device, the common key, and a check result of the first authentication information as arguments, and transmits the second authentication information to the authentication proxy client.

### CROSS-REFERENCE TO RELATED APPLICATIONS

The disclosure of Japanese Patent Application No. 2017-100845 filed on May 22, 2017 including the specification and drawings and abstract is incorporated herein by reference in its entirety.

### BACKGROUND

The present invention relates to an authentication method and an authentication system and, for example, relates to an authentication method and an authentication system using an authentication proxy client.

Particularly, when a network coupling device is coupled to a public line network such as the Internet, the device is always under security attack which is invisible and undetectable. Actually, in advanced research of security, discussion is being made how to detect an attack by malware or the like which cannot be detected prior to occurrence of an incident by behavior abnormality detection. There is incomparably higher security risk in the public line network than before, and it is to be considered that coupling means infection.

Japanese Unexamined Patent Application Publication No. 2015-36257 (patent literature 1) discloses a mechanism of using a device to be authenticated which has the PUF (Physical Uncloanable Function) in a challenge response authenticating process of a vehicle antitheft system. Concretely, information necessary for authentication information configuration is transmitted from an electronic key to a key registration server, and the key registration server generates an offline authentication challenge code and transmits it to a vehicle antitheft device. The vehicle antitheft device sends a UID request to the electronic key, receives a UID from the electronic key, and transmits the offline authentication. challenge code to the electronic key. The electronic key generates a response code and transmits it to the vehicle antitheft device. The vehicle antitheft device performs an electronic key offline authenticating process and, when the authentication succeeds, unlocks the doors of the vehicle.

### SUMMARY

The vehicle antitheft system described in the Japanese Unexamined Patent Application Publication No. 2015-36257 (patent literature 1) has a problem that, when an attack such as falsification occurs, a server or the like cannot grasp the details of the attack.

The other problems and novel features will become apparent from the description of the specification and the appended drawings.

According to an embodiment, in an authentication method executed in an authentication system including an authentication target device, an authentication proxy client, and a server, the authentication target device checks validity of first authentication information generated in the server and, further, the authentication device generates second authentication information and transmits the generated second authentication information to the authentication proxy client.

A device or system expressed by replacing the method of the embodiment, a program making a computer execute processes of the device or a part of the device, and the like are effective as modes of the present invention.

According to the embodiment, when an attack such as falsification occurs, authentication information including information regarding to the details of the attack can be generated.

### BRIEF DESCRIPTION OF THE DRAWINGS

FIG. 1 is a diagram illustrating a flow of an offline authentication protocol according to a first embodiment.

FIG. 2 is a diagram illustrating a flow of the offline authentication protocol according to the first embodiment.

FIG. 3 is a diagram illustrating an example of an attack by a man-in-the-middle according to the first embodiment.

FIG. 4 is a diagram illustrating an example of an attack by a man-in-the middle according to the first embodiment.

FIG. 5 is a diagram illustrating attack resistance of an offline authentication protocol according to the first embodiment.

FIG. 6 is a diagram illustrating attack resistance of an offline authentication protocol according to the first embodiment.

FIG. 7 is a diagram illustrating an example of an attack by a man-in-the middle according to the first embodiment.

FIG. 8 is a diagram illustrating attack resistance of an offline authentication protocol according to the first embodiment.

FIG. 9 is a diagram illustrating the flow of the offline authentication protocol according to the first embodiment.

FIG. 10 is a diagram illustrating an example of an attack by a man-in-the-middle according to the first embodiment.

FIG. 11 is a diagram illustrating attack resistance of the offline authentication protocol according to the first embodiment.

FIG. 12 is a diagram illustrating the flow of an offline authentication protocol according to a second embodiment.

FIG. 13 is a diagram illustrating the flow of the offline authentication protocol according to the second embodiment.

FIG. 14 is a diagram illustrating the flow of an offline authentication protocol according to a third embodiment.

FIG. 15 is a diagram illustrating the flow of the offline authentication protocol according to the third embodiment.

FIG. 16 is a diagram illustrating the flow of an offline authentication protocol according to a fourth embodiment.

FIG. 17 is a diagram illustrating the flow of the offline authentication protocol according to the fourth embodiment.

FIG. 18 is a diagram illustrating the flow of the offline authentication protocol according to the fourth embodiment.

FIG. 19 is a diagram illustrating the flow of the offline authentication protocol according to the fourth embodiment.

FIG. 20 is a configuration diagram of an authentication target device, an authentication proxy client, and a server according to the embodiments.

### DETAILED DESCRIPTION

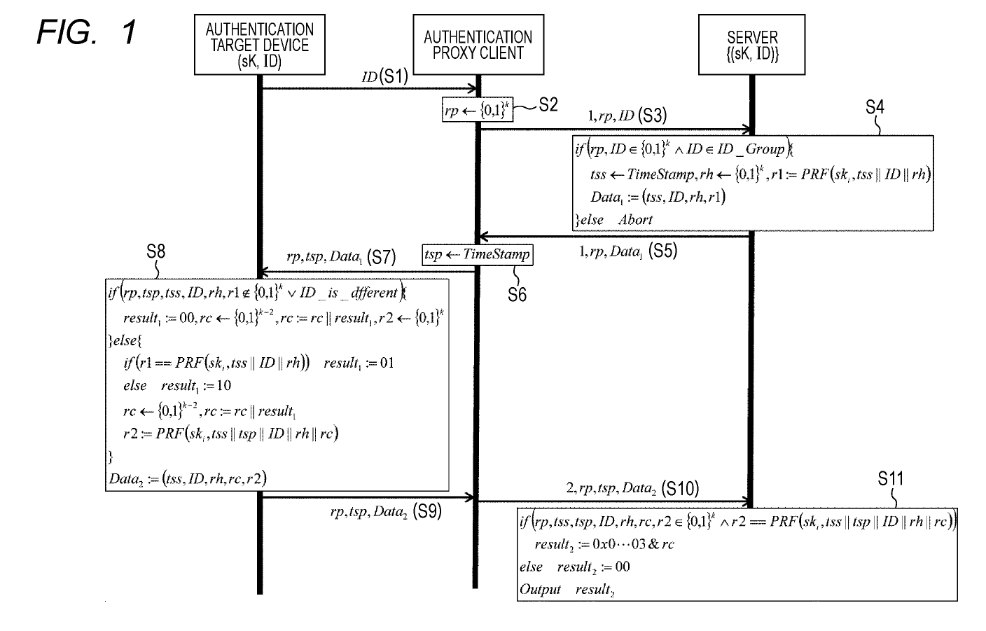

With reference to the sequence chart of FIG. 1, the operation of an offline authentication protocol will be described below. It is assumed that the following settings are made in advance as initial settings of a common symmetric key for an authentication target device.

A security parameter is set as k and a server receives 1̂k. The server selects a symmetric key ski←{0,1}̂k for an authentication target device to which an authentication identifier Idi∈{0,1}̂k is assigned, and transmits (ski,IDi). The authentication target device stores (ski,IDi) into a nonvolatile memory and sends a set ID of the authentication identifier ID to an authentication proxy client. The total number of authentication target devices is set to N and it is set that i∈[1,N]. For example, by performing those processes prior to shipment of authentication target devices, a unique key is set in each of the authentication target devices, and the key may be stored in the server. It is assumed that the authentication proxy client collects the ID of an authentication target device in advance.

### (1) Configuration in Server of Device Authentication Information

The authentication proxy client receives the ID from the authentication target device (S1), selects rp∈{0,1}̂k for session management (S2), and transmits (1,rp,ID) to the server (S3). When (1,rp,ID) is received, the server executes the following procedure (S4).

1. The server verifies whether rp,ID∈{0,1}̂k is satisfied or not and whether ID∈ is satisfied or not. If not satisfied, the server finishes the process. If satisfied, the server executes the following.
2. The server selects the present time as tss←TimeStamp.
3. The server selects a random number as rh←{0,1}̂k.
4. The server calculates r1:=PRF(sk,tss∥ID∥rh). The server sets Data1:=(tss,ID,rh,r1) and transmits (1,rp,Data1) to the authentication proxy client (S5). PRF denotes a Pseudo Random Function, and an operator ‘∥’ expresses a bit conjunction.

### (2) Authentication and Result Collection in Authentication Target Device

The authentication proxy client selects the present time as tsp←TimeStamp (S6) and transmits (rp,tsp,Data1) to the authentication target device (S7). The authentication target device receives (rp,tsp,Data1=(tss,ID,rh,r1)) and executes the following procedure (S8).

1. The authentication target device verifies whether rp,tsp,tss,ID,rh,r1∈{0,1}̂k is satisfied or not, that is, whether the length of each of data is length as a specified value or not, and checks whether the ID matches that of itself. It is assumed here that data is properly padded as necessary. If not satisfied, the authentication target device sets result1:=00,rc←{0,1}̂(k−2),rc:=rc∥result1,r2←{0,1}̂k. If satisfied, the authentication target device executes the following operation.
2. The authentication target device verifies whether r1=PRF(sk,tss∥ID∥rh) satisfied or not. If satisfied, the authentication target device sets result1:=01. If not, the authentication target device sets that result1:=10.
3. The authentication target device selects a random number as rc←{0,1}̂(k−2) and sets that rc:=∥result1∈{0,1}̂k.
4. The authentication target device obtains r2:=PRF(ski,tss∥tsp∥ID∥rh∥rc). The authentication target device sends (rp,tsp,Data2) as Data2:=(tss,ID,rh,rc,r2) to the authentication proxy client (S9).

When there s a time restriction in transmission from the server to the authentication proxy client and tsp is reliable, by comparing tss and tsp at the time of the size check of 1, the check may be performed. When there is a time restriction in the authenticating process in the authentication target device and the clock of the authentication proxy client is reliable, the server may execute the check by comparing tsp and time of reception of the authentication result (hereinbelow, written as tsp2) from the authentication target device.

### (3) Verification of Authentication Result in Server

The authentication proxy client transmits (2,rp,tsp,Data2) to the server (S10). The server receives 2,rp,tsp,Data2=(tss,ID,rh,rc,r2)) and verifies whether rp,tss,tsp,ID,rh,rc,r2∈{0,1}̂k is satisfied, that is, the length of each of the data is the length as the specific value or not. If not satisfied, the server sets that result2:=00. It is assumed here that the data is properly padded as necessary. If satisfied, the server verifies whether r2=PRF(sk,tss∥tsp∥ID∥rh∥rc is satisfied or not. If correct, the server sets the lower two bits of result2:=rc. If not, the server sets that result2:=00. The server outputs result2 as the authentication result and records it (S11).

When result2 is 01, authentication success in the authentication target device is recorded. When result2 is 10, authentication failure is recorded. When result2 is 00, a reception error (possibility of message falsification) is recorded.

When there is a time restriction since transmission of authentication information from the server to the authentication proxy client until the server obtains an authentication result from the client, the size check may be performed by comparing tss with present time in the server. When there is a time restriction in transmission of an authentication result from the authentication proxy client to the server and the clock of the authentication proxy client is reliable, the check may be performed by additionally transmitting tsp2 from the authentication proxy client to the server and comparing tsp and tss in the server.

In the protocol, when rp is falsified, a corresponding session becomes non-existing. Even a corresponding session exists, authentication in an authentication target device is executed in a different session and fails, so that it is fail-safe. Also in the case of falsification of rh, verification of an authentication result in a server fails, so that it is fail-safe. By authentication result verifying means in a server, even when an attacker falsifies the value of rc, the result does not pass the verification in the server. Also in the case where tsp is falsified, by the authentication result verifying means in the server, the result does not pass the verification in the server.

That is, even when any of rp, rc, and tsp is falsified, the attacker cannot obtain authentication success and verification pass on the authentication result of the authentication target device. When all or any of rp, rh, and rc are/is falsified, for example, the server can detect the falsification.

For the purpose of efficiently detecting authentication failure and verification failure by falsification, a hash value may be added to tsp.

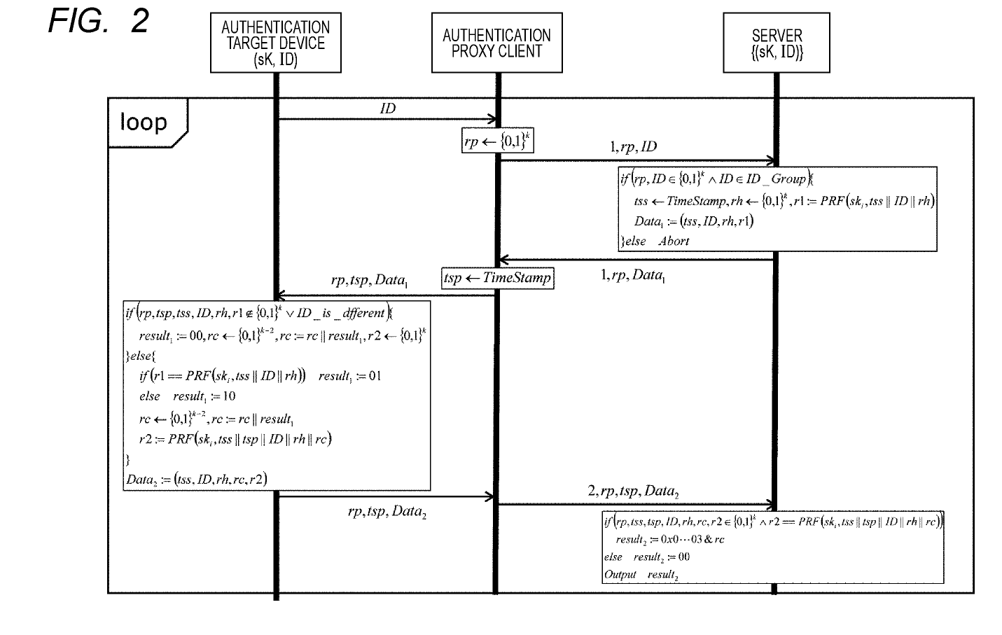

The above-described operations (1), (2), and (3) are repetitively executed in the sequence illustrated in FIG. 2. Messages in FIG. 2 are executed by the operations defined below. ITU-TS Recommendation Z.120: Message Sequence Chart (MSC), ITU-TS, Geneva, 2011.

### ITU-TS Recommendation Z.120: Message Sequence Chart (MSC) Annex B: Algebraic Semantics of Message Sequence Charts, ITU-TS, Geneva, 1995.

### Safety and Measure to be Satisfied by Offline Authentication Protocol

There are a man-in-the-middle (MITM) attack and a replay attack for safety to be considered at the time of authenticating process.

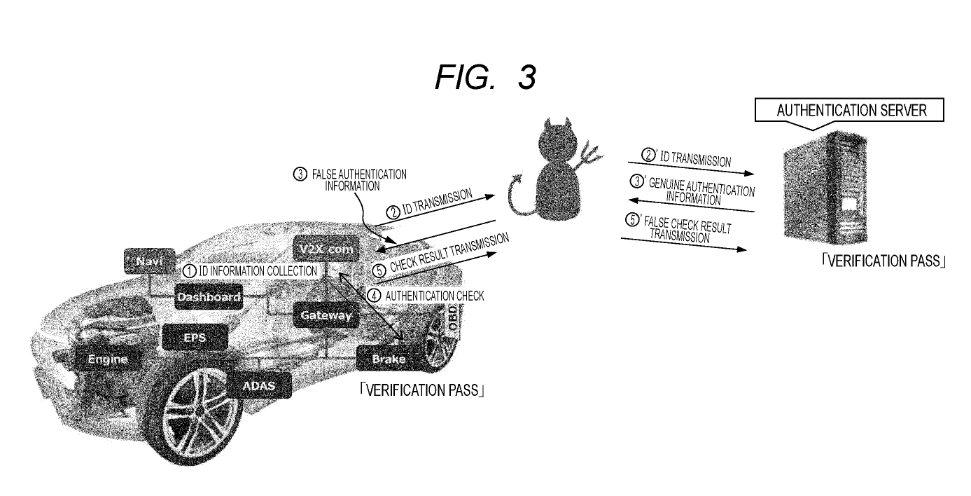

FIG. 3 illustrates an example of a MITM attack by tapping (in the case of offline, sealing) in a communication path and falsification of transmission data. An example of a scenario of erroneous authentication by falsification in stealing is as follows.

1. Collection of the ID of an authentication target device by an in-vehicle gateway or the like
2. Transmission of the ID collected by the in-vehicle gateway or the like to an authentication server 2′. An MITM attacker falsifies the ID and transmits the falsified ID to the authentication server
3′. The authentication server sends as a response genuine authentication information to the received falsified ID
3. The MITM attacker replaces the genuine authentication information with false authentication information and sends the false authentication information to the in-vehicle gateway or the like
4. Device authentication using the false authentication information by the in-vehicle gateway or the like
5. Transmission of a device authentication result by the in-vehicle gateway or the like to the authentication server
5′. The MITM attacker falsifies the device authentication result and transmits the falsified result to the authentication server

In the above case, when the authentication server recognizes the device authentication as verification pass, the attack of the MITM attacker succeeds. For example, the authentication target device can be replaced to a non-genuine device. Also in the case where authentication of an authentication target device succeeds and the authentication server recognizes the device authentication as verification pass, the attack of the MITM attacker succeeds. For example, an unauthorized user can use the device.

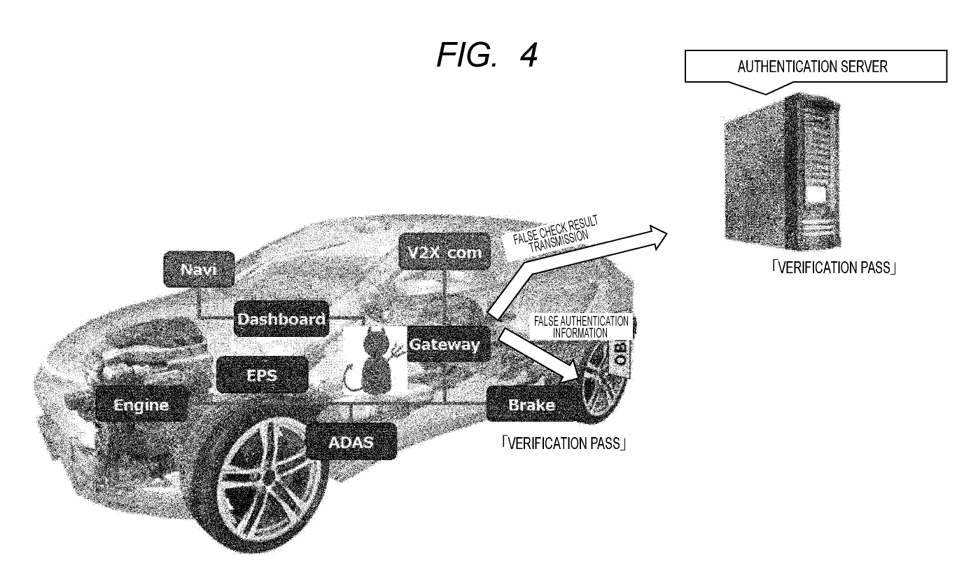

FIG. 4 illustrates an example of an attack of erroneous authentication by dropping malware in a gateway or another control device as an in-vehicle relay and transmitting false information to an authentication target device and an authentication server as attack targets. A scenario in the example is, for instance, as follows.

1 Malware authenticates the authentication target device by using false authentication information
2 The malware transmits the false authentication information to the authentication server

Whether an attack of a MITM attacker succeeds or not is similar to that in FIG. 3. As scenarios to be considered for safety, the followings can be mentioned as attacking methods using a MITM attack.

Case 1. Change of the length of a message transmitted to an authentication target device
Case 2. Change of the content of a message transmitted to an authentication target device
Case 3. Change of the length of a message transmitted to an authentication target device
Case 4. Change of the content of a message transmitted to an authentication server

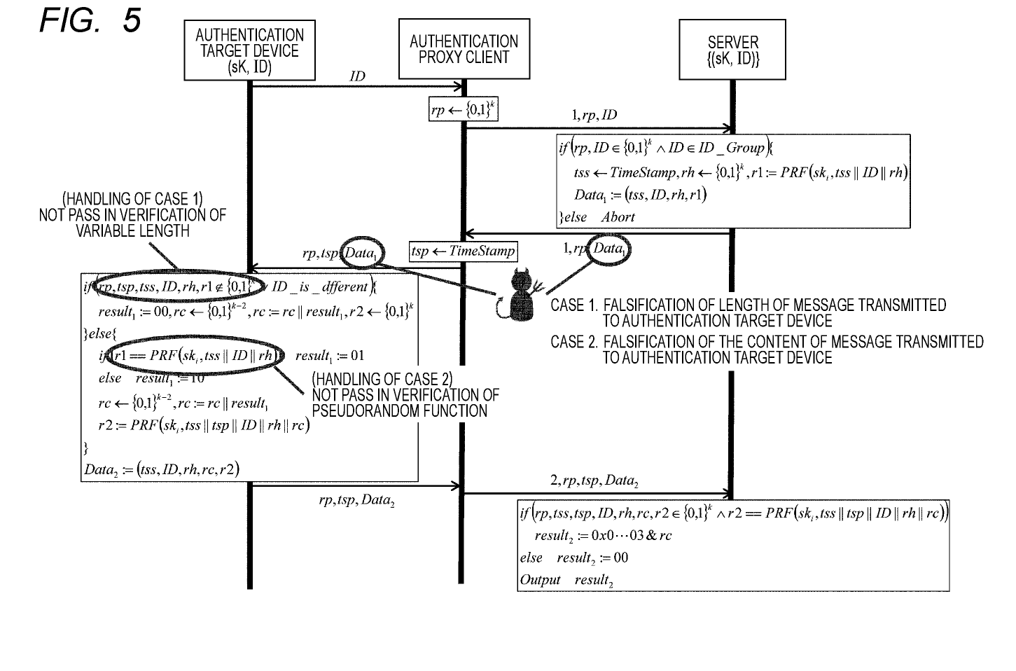

FIG. 5 illustrates that measures are taken to the cases 1 and 2 in the offline authentication protocol in FIG. 1. Concretely, as a measure to the case 1, in an authentication target device, first, message length is verified to eliminate an attack by a message length change. Further, as a measure to the case 2, in the authentication target device, falsification of a message is verified by using a pseudo random function to eliminate an attack by changing the content of a message.

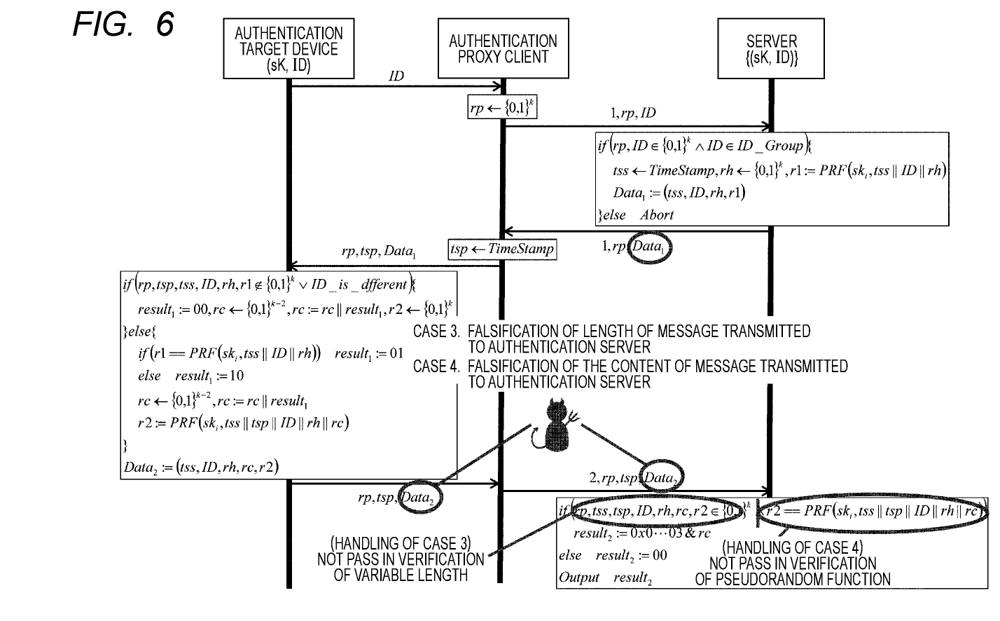

FIG. 6 illustrates that measures are taken to the cases 3 and 1 in the offline authentication protocol in FIG. 1. Concretely, as a measure to the case 3, in the authentication server, first, message length is verified to eliminate an attack by a message length change. Further, as a measure to the case 4, in the authentication server, falsification of a message is verified by using a pseudo random function to eliminate an attack by changing the content of a message.

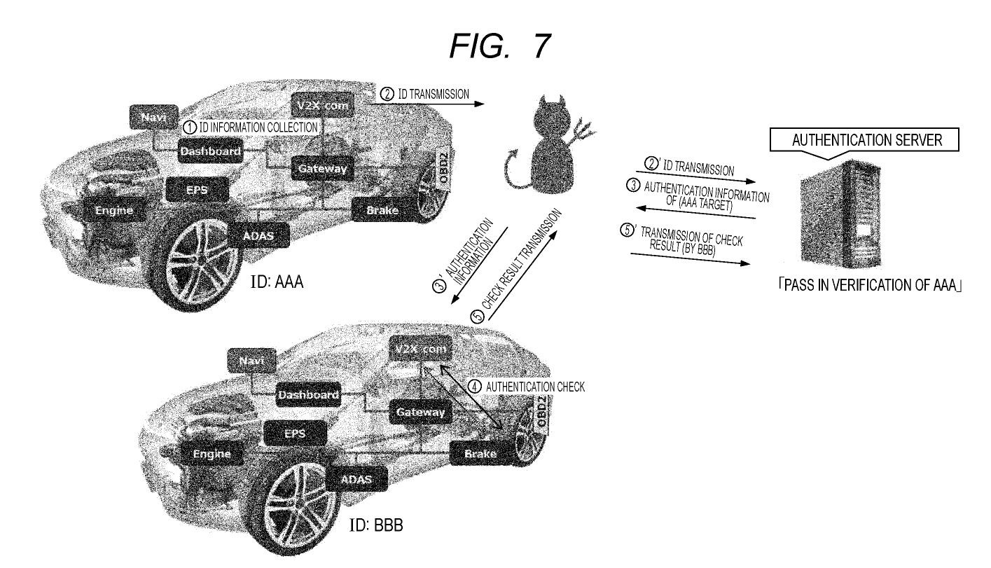

FIG. 7 illustrates an example of a replay attack by a destination change that an MITM attacker repetitively uses data transmitted from the authentication server, transmits authentication information without a change to another terminal which is not an authentication target device and is not originally to be authenticated, and relays the result as it is to the server, thereby avoiding authentication to the authentication target device which is originally to be authenticated. An example of a scenario of erroneous authentication by a replay attack by a destination change is as follows.

1. Collection of the ID of AAA of an authentication target device by an in-vehicle gateway or the like
2. Transmission of the collected ID AAA to an authentication server by the in-vehicle gateway or the like
2′. Transmission of the ID of AAA from a MITM attacker to the authentication server
3. Response of genuine authentication information to the ID of AAA from the authentication server
3′. The MITM attacker replaces the authentication information with false authentication information and sends the false authentication information to the in-vehicle gateway or the like
4. Authentication of a device having the ID of BBB using the replaced authentication information by the in-vehicle gateway or the like
5. Transmission of a device authentication result of the device having the ID of BBB to the authentication server by the in-vehicle gateway or the like
5′. Transmission of the device authentication result of the ID of BBB to the authentication server by the MITM attacker

In the above case, when the authentication server recognizes the device authentication as verification pass, the attack of the MITM attacker succeeds. For example, the authentication target device can be replaced to a non-genuine device.

As a scenario to be considered for safety, the following can be mentioned as an attacking method using a replay attack (a destination change).

Case 5. Transmission to a different authentication target device

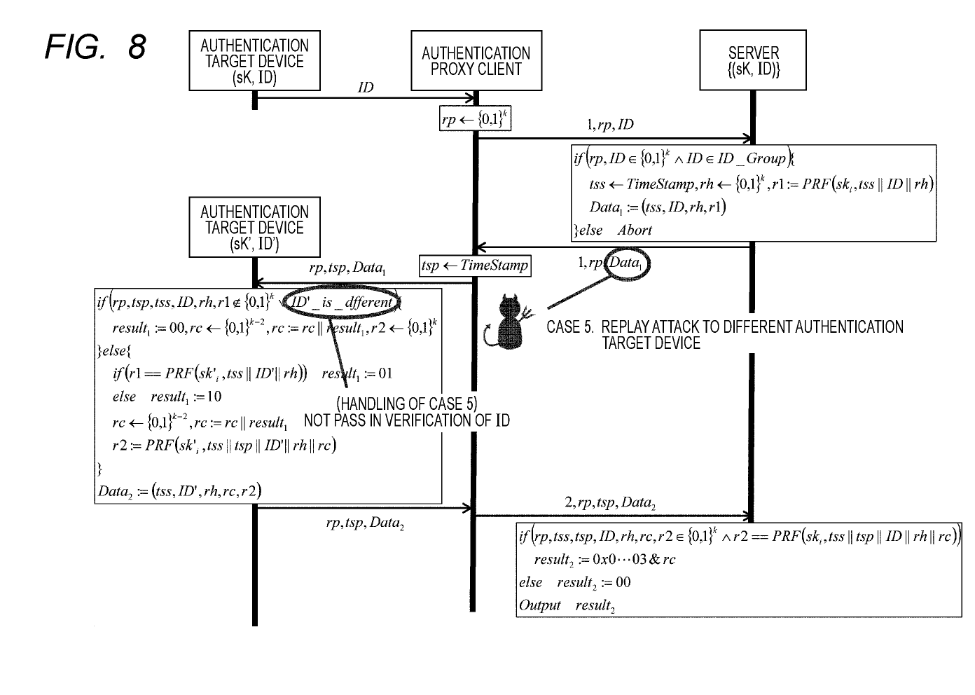

FIG. 8 illustrates that a measure to the case 5 is taken in the offline authentication protocol of FIG. 1. Concretely, as a handling of the case 5, an authentication target device verifies whether the ID of the authentication target device matches or not to eliminate an attack by transmission to a different authentication target device

### One-Time Offline Authentication Protocol

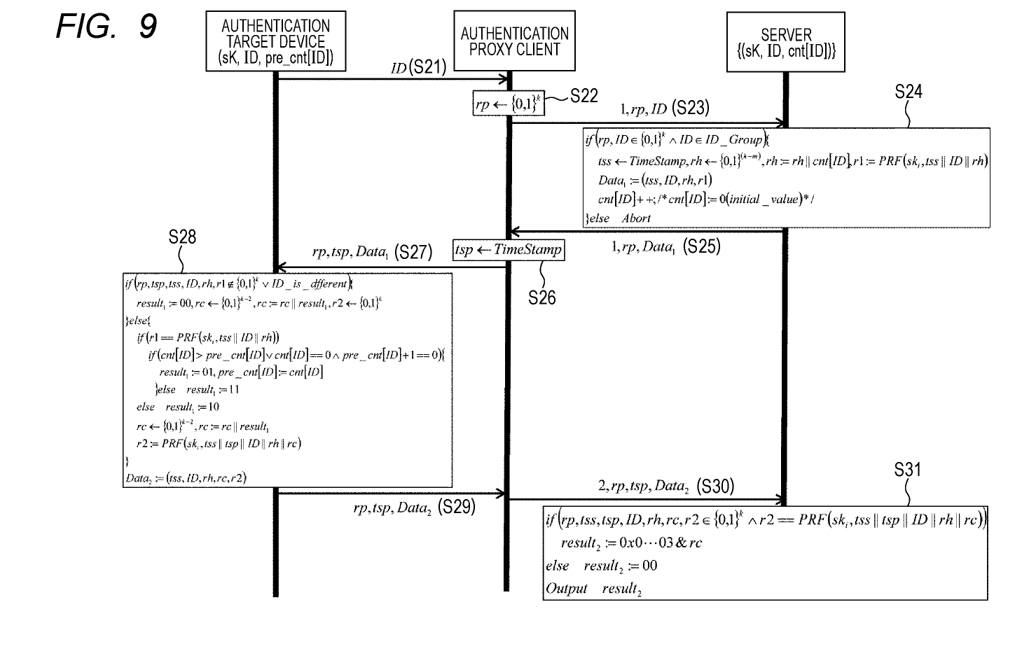

The case of the offline authentication protocol illustrated in FIG. 1 has a problem that authentication information stored in an authentication proxy client can be used repeatedly for authentication of a corresponding authentication target device. Although there is a method of limiting the number of times of authentication, if this part is falsified, the authentication information can be exploited. To handle the problem, FIG. 9 illustrates one-time authentication, that is, extension of limiting the number of authentication times in an authentication target device in each authentication information to at most once by introducing a monotonic counter.

Hereinbelow, change points from FIG. 1 will be mainly described. It is assumed that each of monotonic counters (server: cnt[j] and authentication target device: pre_cnt[j] (∀j∈[1,N]) for the server and the authentication target device is initially set to zero in advance. It is also assumed that the monotonic counter value is automatically updated and cannot be changed by the user, and cannot be changed to zero by resetting, power-supply disconnection, or the like except for the first initialization in a method other than a method that the value becomes zero due to overflow by counting-up.

Although a monotonic counter is introduced implicitly in FIG. 9, it may be replaced by the server time tss. It is assumed that an authentication proxy client collects the ID of an authentication target device in advance.

### (1) Configuration in Server of Device Authentication Information

An authentication proxy client receives the ID from an authentication target device (S21), selects rp∈{0,1}̂k for session management (S22), and transmits (1,rp,ID) to a server (S23). The server receives (1,rp,ID) and executes the following procedure (S24).

1. The server verifies whether rp,ID∈{0,1}̂k is satisfied or not and whether ID∈ID is satisfied or not. If not satisfied, the server finishes the process. If satisfied, the server executes the following.
2. The server selects the present time as tss←TimeStamp.
3. The server selects a random number as rh←{0,1}̂k−m, rh:=rh∥cnt[ID]. cnt[ID] denotes a monotonic counter value of the initial value zero corresponding to the ID.
4. The server calculates r1:=PRF(sk,tss∥ID∥rh). The server transmits (1,rp,Data1) as Data1:=(tss,ID,rh,r1) to the authentication proxy client (S25). After the transmission, the server increments cnt[ID]. PRF denotes a pseudo random function, and the operator ‘∥’ expresses bit conjunction.

### (2) Authentication and Result Collection in Authentication Target Device

The authentication proxy client selects the present time as tsp←TimeStamp (S26) and transmits (rp,tsp,Data1) to the authentication target device (327). The authentication target device receives (rp,tsp,Data1=(tss,ID,rh,r1)) and executes the following procedure (S28).

1. The authentication target device verifies whether rp,tsp,tss,ID,rh,r1∈{0,1}̂k is satisfied or not, that is, whether the length of each of the data is equal to the length of a specified value or not and checks if the ID matches that of itself. It is assumed here that data is properly padded as necessary. If not satisfied, the authentication target device sets that result1:=00,rc←{0,1}̂(k−2), rc:=rc∥result1,r2←{0,1}̂k. If satisfied, the authentication target device executes the following operations.
2. The authentication target device verifies whether r1=PRF(sk,tss∥ID∥rh) satisfied or not. If satisfied, the authentication target device executes the following processes. If not satisfied, the authentication target device sets that result1:=10 and shifts the process to 4.
3. The authentication target device checks whether cnt[ID]>pre_cnt[ID] or cnt[ID]==0̂pre_cnt[ID]+1==0 is satisfied or not and, if satisfied, sets that result1:=01 and pre_cnt[ID]:=cnt[ID]. If not satisfied, the authentication target device sets that result1:=11. pre_cnt[ID] denotes a monotonic counter whose initial value is zero, held by an authentication target device corresponding to the ID.
4. The authentication target device selects a random number as rc←{0,1}̂(k−2) and sets that rc:=rc∥result1∈{0,1}̂k.
5. r2:=PRF(ski,tss∥tsp∥ID∥rh∥rc) is obtained. The authentication target device transmits (rp,tsp,Data2) using Data2:=(tss,ID,rh,rc,r2) to the authentication proxy client (S29).

When there is a time restriction in transmission from the server to the authentication proxy client and tsp is reliable, the size check in the above-described operation 1 may be executed by comparing tss and tsp. When there is a time restriction for the authenticating process in the authentication target device and the clock of the authentication proxy client is reliable, the server may execute the check by comparing tsp and time of reception of the authentication result from the authentication target device (hereinbelow, described as tsp2).

### (3) Verification of Authentication Result in Server

The authentication proxy client transmits (2,rp,tsp,Data2) to the server (S30). The server receives (2,rp,tsp, Data2=(tss,ID,rh,rc,r2)) and verifies whether rp,tss,tsp,ID,rh,rc,r2∈{0,1}̂k is satisfied or not, that is, whether the length of each of data is the length as the specified value or not. If not satisfied, the server sets that result2:=00. It is assumed that the data is properly padded as necessary. If satisfied, the server verifies whether r2=PRE(sk,tss∥tsp∥ID∥rh∥rc) is satisfied or not and, if correct, sets the lower two bits of result2:=rc. If not, the server sets that result2:=00. The server outputs result2 as the authentication result and records it (S31).

When result2 is 01, authentication success in the authentication target device is recorded. When result2 is 11, authentication failure due to reuse of authentication information is recorded. When result2 is 10,authentication failure due to pseudo random function value mismatch is recorded. When result2 is 00, a reception error (possibility of message falsification) is recorded.

When there is a time restriction since transmission of authentication information from the server to the authentication proxy client until the server obtains an authentication result from the authentication proxy client, the size check may be performed by comparing tss and present time in the server. When there is a time restriction in transmission of an authentication result from the authentication proxy client to the server and the clock of the authentication proxy client is reliable, the check may be performed by additionally transmitting tsp2 from the authentication proxy client to the server and comparing tsp2 and tss in the server.

In the protocol, when rp is falsified, a corresponding session becomes non-existing. Even a corresponding session exists, authentication in an authentication target device is executed in a different session and fails, so that it is fail-safe. Also in the case of falsification of rh, verification of an authentication result in a server fails, so that it is fail-safe. By authentication result verifying means in a server, even when an attacker falsifies the value of rc, the result does not pass the verification in the server. Also in the case where tsp is falsified, by the authentication result verifying means in the server, the result does not pass the verification in the server.

Even any of rp, rc, and tsp is falsified, the attacker cannot obtain authentication success and verification pass on the authentication result of the authentication target device. When all or any of rp, rh, and rc are/is falsified, for example, the falsification can be detected.

For the purpose of efficiently detecting authentication failure and verification failure by falsification, a hash value may be added to tsp.

Repetitive execution of the above-described operations (1), (2), and (3) is defined in a manner similar to that in the sequence illustrated in FIG. 2.

### Safety and Measures to be Satisfied by One-Time Offline Authentication Protocol

It is obvious from the way how the protocol is configured that the one-time offline authentication protocol illustrated in FIG. 9 has resistance to the attacks of the cases 1 to 5. As safety to be considered, a replay attack by repetitive use of the same data will be newly described.

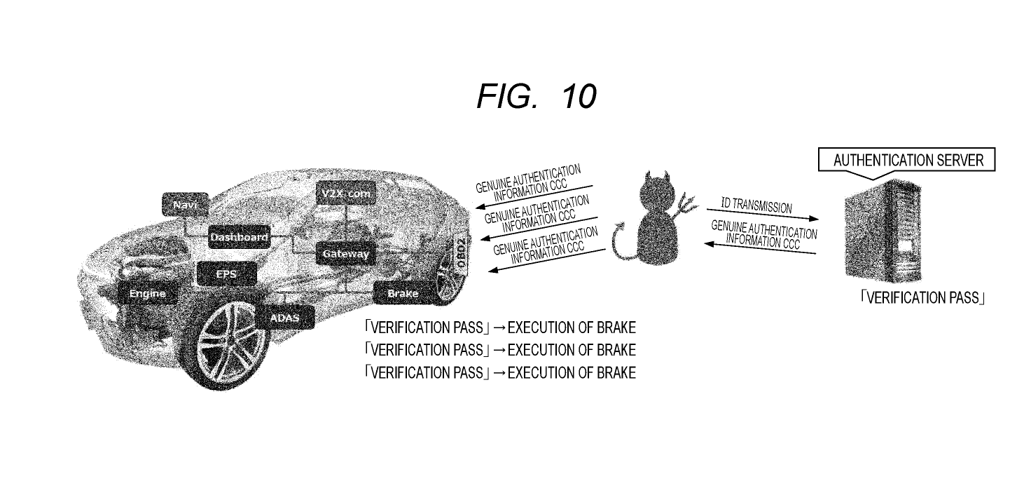

FIG. 10 illustrates an example of an attack that an MITM attacker repetitively uses data once obtained from an authentication server and transmits the same data again and again to an authentication target device, thereby succeeding in authentication at any time and executing the function of the authentication target device at any time.

A scenario example of the attack is that an MITM attacker repetitively uses genuine authentication information CCC obtained by ID authentication and executes an operation which can be executed with the authentication information CCC at any timing.

In a scenario to be considered for safety, there is the following attacking method using a replay attack (repetitive use of the same data).

Case 6. A plurality of times of transmission to the authentication target device using the same data

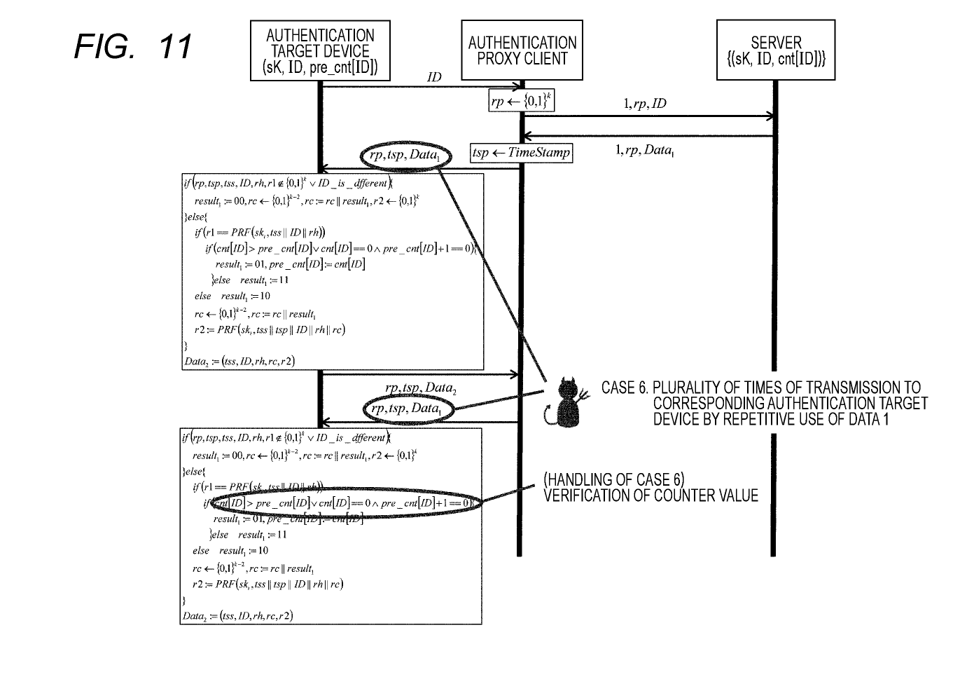

FIG. 11 illustrates that a measure is taken to the case 6 in the one-time offline authentication protocol of FIG. 9. As a measure to the case 6, in an authentication target device, a counter value is verified and, since the counter value is updated so as to be incremented for each device authentication, an attack by repetitively using the same authentication information is eliminated.

By executing the offline authentication protocol described an the first embodiment as described above, the following effects can be obtained.

1) On precondition that a server and an authentication target device have a common key in advance, an authentication proxy (authentication proxy client) transmits a session identifier for recognizing a corresponding relation between identifier information of the authentication target device corrected and communication to the server, and authentication information is configured from the identifier of the authentication target device and the common key in the server. The server sends back the authentication information to the authentication proxy, and the authentication proxy authenticates the authentication target device by using the identification information. Regardless of the result of the authentication executed after confirming that there is no defect in the authentication information, the authentication proxy transmits an authentication result constructed by a pseudo random function using the common key as a response to the server. By verifying the authentication result in the server, authentication of the authentication target device can be securely realized.
2) In a server, coding/decoding process becomes unnecessary in the authentication result verification.
3) Without accompanying signature issuance verification targeted at a communication path, in authentication result verification in a server, falsification can be detected not only by the result of authentication of authentication target device but also transmission of an authentication result from the authentication target device to the server.
4) An attack by repetitive use of authentication information can be suppressed.

### Second Embodiment

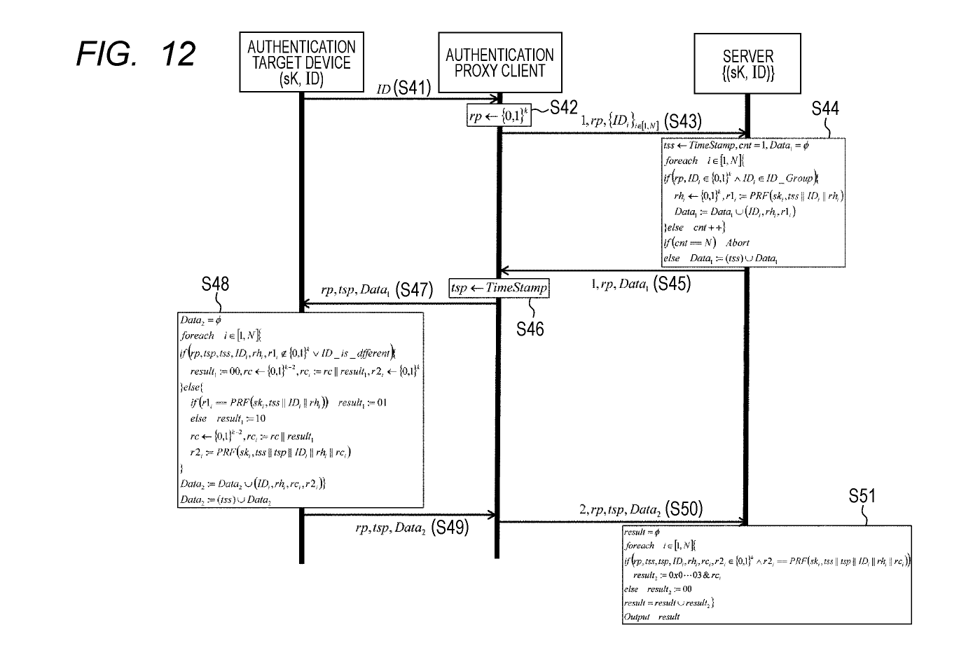

With reference to the sequence chart of FIG. 12, the operation of an offline authentication protocol according to a second embodiment will be described. It is assumed that the following settings are made in advance as an initial setting of a common symmetric key for an authentication target device.

A security parameter is set as k and a server receives 1̂k. The server selects a symmetric key ski←{0,1}̂k for an authentication target device to which an authentication identifier Idi∈{0,1}̂k is assigned, and transmits (ski,IDi). The authentication target device stores (ski,IDi) into a nonvolatile memory and sends a set ID of the authentication identifier ID to an authentication proxy client. The total number of authentication target devices is set to N and i∈[1,N] is set. For example, by performing those processes prior to shipment of authentication target devices, a unique key is set in each of the authentication target devices, and the key may be stored in the server. It is assumed that the authentication proxy client collects the ID of an authentication target device in advance.

### (1) Configuration in Server of Device Authentication Information

The authentication proxy client receives the ID from the authentication target device (S41) selects rp∈{0,1}̂k for session management (S42), and transmits (1,rp, {IDi; i∈[1,N]}) together with the set {IDi; i∈[1,N]} of IDs of an authentication target device group to the server (S43). The transmission may be realized not via a network but by delivering a storage medium in which information is written.

The server receives (1,rp, {IDi; i∈[1,N]}) and executes the following procedure (S44).

1. The server selects the present time as tss←TimeStamp and sets that cnt:=1 and Data1:Φ (empty set).
2. The server performs the following operations 3, 4, 5, and 6 for each of i∈[1,N].
3. The server verifies whether rp,IDi∈{0,1}̂k is satisfied or not and whether IDi∈ID is satisfied or not. If not, the server increments cnt and shifts the process to 6. If satisfied, the server executes the following.
4. The server selects a random number as rhi←{0,1}̂k.
5. The server calculates r1i:=PRF(ski,tss∥Idi∥rhi).
6. The server sets that Data1:=(IDi,rhi,r1i)∪Data1 and increments “i”. The operator ‘∥’ expresses a bit conjunction.
7. If cnt==N, the server finishes the process. If not, the server sets that Data1:=(tss)∪Data1 and transmits (1,rp,Data1) to the authentication proxy client (S45). The transmission may not be performed via a network but may be realized by delivering a storage medium in which information is written.

### (2) Authentication and Result Collection in Authentication Target Device

The authentication proxy client selects the present time as tsp←TimeStamp (S46) and transmits (rp,tsp,Data1) to the authentication target device (S47).

The authentication target device receives (rp,tsp,Data1={(tss,IDi,rhi,r1); i∈[1,N]}) and executes the following procedure (S48). The reception may be realized not via a network but by receiving a storage medium in which information is written.

1. Data2:=Φ (empty set)
2. The authentication target device executes the following operations 3, 4, 5, 6, and 7 for each i∈[1,N].
3. The authentication target device verifies whether rp,tsp,tss,IDi,rhi,r1∈{0,1}̂k is satisfied or not, that is, whether the length of each data becomes the length as a specified value or not, and checks whether IDi matches the ID of itself. It is assumed that data is properly padded as necessary. If not satisfied, the authentication target device sets that result1:=00,rc←{0,1}̂(k−2), rci:=rc∥result1,r2i←{0,1}̂k, and shifts the process to 7. If satisfied, the authentication target device executes the following operations.
4. The authentication target device verifies whether r1i=PRF(ski,tss∥ID∥rhi) is satisfied or not. If satisfied, the authentication target device sets that result1:=01. If not satisfied, the authentication target device sets that result1:=10.
5. The authentication target device selects a random number as rc←{0,1}̂(k−2) and sets that rci:=rc∥result1∈{0,1}̂k.
6. The authentication target device obtains r2i:=PRF(ski,tss∥tsp∥IDi∥rhi∥rci).
7. The authentication target device sets that Data2:=(tss,IDi,rhi,rci,r2)∪Data2, and increments “i”.
8. The authentication target device sets that Data2:=(tss)∪Data2, and transmits (rp,tsp,Data2) to the authentication proxy client (S49). The transmission may be realized not via a network but by transmitting a storage medium in which information is written.

When there is a time restriction in transmission from the server to the authentication proxy client and tsp is reliable, by comparing tss and tsp at the time of the verification of 1, the check may be executed. When there is a time restriction in the authenticating process in the authentication target device and the clock of the authentication proxy client is reliable, the server may execute the check by comparing tsp and time of reception of the authentication result (hereinbelow, written as tsp2) from the authentication target device.

### (3) Verification of Authentication Result in Server

The authentication proxy client transmits (2,rp,tsp, Data2) to the server (S50). The server receives (2,rp,tsp,Data2={(tss,IDi,rhi,rci,r2i); i∈[1,N]} and executes the following procedure (S51).

1. result:=∪
2. The server executes the following operations 3, 4, and 5 for each i∈[1,N].
3. The server verifies whether rp,tss,tsp,IDi,rhi,rci,r2i∈{0,1}̂k is satisfied or not, that is, whether the length of each data is the length as a specified value or not. If not satisfied, the server sets that result2:=00 and shifts the process to 5. It is assumed here that data is properly padded as necessary. If satisfied, the following is executed.
4. The server verifies whether r2i=PRF(sk,tss∥tsp∥IDi∥rhi∥rci) is satisfied or not. If correct, the server sets the lower two bits of result2:=rc. If not, the server sets that result2:=00. When result2 is 01, authentication success in the authentication target device is recorded. When result2 is 10, authentication failure is recorded. When result2 is 00, a reception error (possibility of message falsification) is recorded.
5. result:=result∪result2 is set and “i” is incremented.
6. result is output as an authentication result and recorded.

When there is a time restriction since transmission of authentication information from a server to an authentication proxy client until the server obtains an authentication result from the authentication proxy client, the server may execute the size check in the above operation 3 by comparing tss with present time in the server.

When there is a time restriction in transmission of an authentication result from the authentication proxy client to the server and the clock of the authentication proxy client is reliable, the check may be performed by additionally transmitting tsp2 from the authentication proxy client to the server and comparing tsp2 and tss in the server.

In a manner similar to the case of FIG. 1, also in the protocol illustrated in FIG. 12, when rp is falsified, authentication in the authentication target device fails, so that it is fail-safe. Also in the case of falsification of rh, verification of an authentication result in the server fails, so that it is fail-safe. By authentication result verifying means in a server, even when an attacker falsifies the value of rc, the result does not pass the verification in the server. Also in the case where an attacker falsifies tsp, by the authentication result verifying means in the server, the result does not pass the verification in the server.

That is, even when any of rp, rc, and tsp is falsified, the attacker cannot obtain authentication success and verification pass on the authentication result of the authentication target device. When all or any of rp, rh, and rc are/is falsified, the server can detect the falsification. For the purpose of efficiently detecting authentication failure and verification failure by falsification, a hash value may be added to tsp.

Repetitive execution of the above-described operations (1), (2), and (3) is defined in a manner similar to that in the sequence illustrated in FIG. 2.

### Safety and Measure to be Satisfied by Offline Batch Authentication Protocol

As obvious from the way of the configuration, the authentication protocol in the second embodiment has resistance to attacks of the cases 1 to 5.

### One-Time Offline Batch Authentication Protocol

The case of FIG. 12 has a problem that authentication information stored in the authentication proxy lent can be repeatedly used for authentication of a corresponding authentication target device. Although there is a method of limiting the number of times of authentication, when this part is falsified, abuse of authentication information becomes possible.

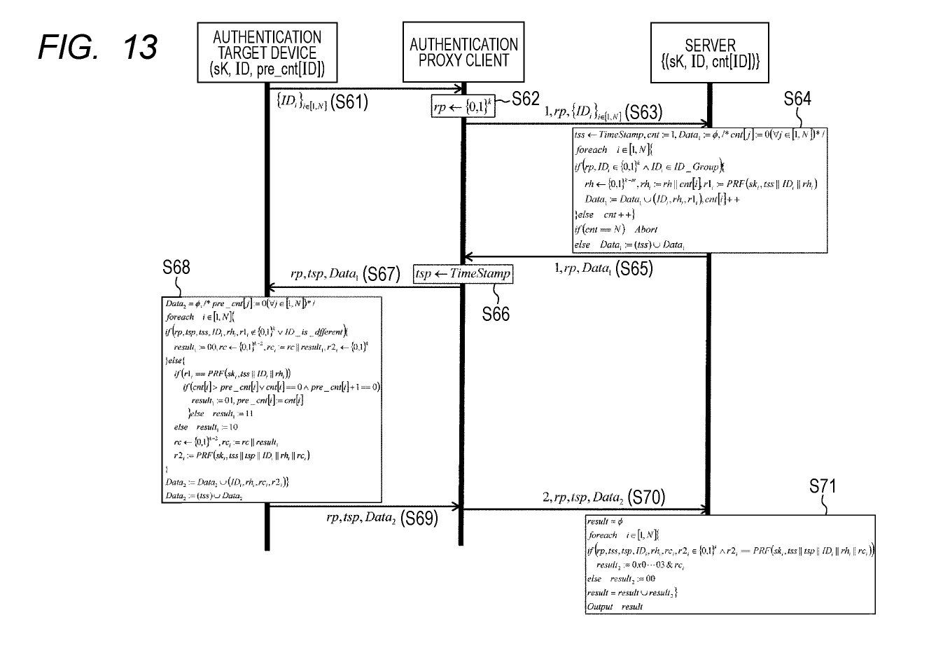

FIG. 13 illustrates one-time authentication, that is, extension of limiting the number of times of authentication in an authentication target device with each authentication information to at most once by introducing a monotonic counter. Hereinbelow, the points changed from FIG. 12 will be mainly described with reference to FIG. 13. It is assumed that each of monotonic counters (server: cnt[j] and authentication target device: pre_cnt[j] (∀j∈[1,N]) for the server and the authentication target device is initially set to zero in advance. It is also assumed that the monotonic counter value is automatically updated and cannot be changed by the user, and cannot be changed to zero by resetting, power-supply disconnection, or the like except for the first initialization in a method other than a method that the value becomes zero due to overflow by counting-up.

Although a monotonic counter is introduced implicitly in FIG. 13, it may be replaced by the server time tss. It is assumed that an authentication proxy client collects the ID of an authentication target device in advance as described hereinafter.

A security parameter is set as k and a server receives 1̂k. The server selects a symmetric key ski←{0,1}̂k for an authentication target device to which an authentication identifier Idi∈{0,1}̂k is assigned, and transmits (ski,IDi). The authentication target device stores (ski,IDi) into a nonvolatile memory and sends a set ID of the authentication identifier IDi to an authentication proxy client.

The total number of authentication target devices is set to N and i∈[1,N] is set. For example, by performing those processes prior to shipment of authentication target devices, a unique key is set in each of the authentication target devices, and the key may be stored in the server.

### (1) Configuration in Server of Device Authentication Information

An authentication proxy client receives {IDi; i∈[1,N]} from an authentication target device (S61), selects rp∈{0,1}̂k for session management (S62), and transmits (1,rp,{IDi; i∈[1,N]}) together with the set of IDs {IDi; i∈[1,N]} of the authentication target device group to a server (S63). The transmission may be realized not via a network but by delivering a storage medium in which information is written.

The server receives (1,rp,{IDi; i∈[1,N]}) and executes the following procedure (S64).

1. The server selects the present time as tss TimeStamp. The server sets that cnt:=1 and Data1:=Φ (empty set)
2. The server executes the following operations 3, 4, 5, and 6 for each of i∈[1,N].
3. The server verifies whether rp,Idi∈{0,1}̂k is satisfied or not and whether Idi∈ID is satisfied or not. If not, the server increments cnt and shifts the process to 6. If satisfied, the server executes the following.
4. The server selects a random number as rh←{0,1}̂k−m, rh:=rh∥cnt[i]. cnt[i] indicates a monotonic counter value of the initial value zero corresponding to IDi.
5. The server calculates r1i:=PRF(ski,tss∥IDi∥rhi).
6. The server sets that Data1:=(IDi,rhi,r1i)∪Data1 and increments “i”. After that, the server increments cnt[i]. The operator ‘∥’ expresses a bit conjunction.
7. If cnt==N, the server finishes the process. If not, the server sets that Data1:=(tss)∪Data1, and transmits (1,rp,Data) to the authentication proxy client (S65). The transmission may not be performed via a network but may be realized by delivering a storage medium in which information is written.

### (2) Authentication and Result Collection in Authentication Target Device

The authentication proxy client selects the present time as tsp←TimeStamp (S66) and transmits (rp,tsp,Data1) to the authentication target device (S67).

The authentication target device receives (rp,tsp,Data1={(tss,IDi,rhi,r1i); i∈[1,N]}) and executes the following procedure (S68). The reception may be realized not via a network but by receiving a storage medium in which information is written.

1. Data2:=Φ (empty set)
2. The authentication target device executes the following operations 3, 4, 5, 6, and 7 for each i∈[1,N].
3. The authentication target device verifies whether rp,tsp,tss,IDi,rhi,r1i{0,1}̂k is satisfied or not, that, is, whether the length of each data becomes the length as a specified value or not, and checks whether IDi matches that of itself. It is assumed that data is properly padded as necessary. If not satisfied, the authentication target device sets that result1:=00,rc←{0,1}̂(k−2),rci:=rc∥result1,r2i←{0,1}̂k, and shifts the process to 7. If satisfied, the authentication target device executes the following operations.
4. The authentication target device verifies whether r1i=PRF(ski,tss∥IDi∥rhi) is satisfied or not. If satisfied, the authentication target device executes the following processes. If not satisfied, the authentication target device sets that result1:=10, and shifts the process to 4.
5. The authentication target device checks whether cnt[i]>pre_cnt[i] or cnt[i]==0̂pre_cnt[i]+1−−0 is satisfied or not. If satisfied, the authentication target device sets that result1:=01 and pre_cnt[i]:=cnt[i]. If not satisfied, the authentication target device sets that result1:=11. pre_cnt[i] indicates a monotonic counter having an initial value of zero of the authentication target device corresponding to IDi.
6. The authentication target device selects a random number as rc←{0,1}̂(k−2), and sets that rci:=rc∥result1∈{0,1}̂k.
7. The authentication target device obtains r2i:=PRF(ski,tss∥tsp∥IDi∥rhi∥rci).
8. The authentication target device sets that Data2:=(tss,IDi,rhi,rci,r2)∪Data2, and increments “i”.
9. The authentication target device sets that Data2:=(tss)∪Data2, and transmits (rp,tsp,Data2) to the authentication proxy client (S69). The transmission may be realized not via a network but by transmitting a storage medium in which information is written.

When there is a time restriction in transmission from the server to the authentication proxy client and tsp is reliable, by comparing tss and tsp in the verification 1, the check may be executed. When there is a time restriction in the authenticating process in the authentication target device and the clock of the authentication proxy client is reliable, the server may execute the check by comparing tsp and time of reception of the authentication result (hereinbelow, written as tsp2) from the authentication target device.

### (3) Verification of Authentication Result in Server

The authentication proxy client transmits (2,rp,tsp,Data2) to the server (S70). The server receives (2,rp,tsp,Data2={(tss,IDi,rhi,rci,r2i); i∈[1,N]}) and executes the following procedure (S71).

1. result:=Φ
2. The server executes the following operations 3, 4, and 5 for each i∈[1, N].
3. The server verifies whether rp,tss,tsp,IDi,rhi,rci,r2i∈{0,1}̂k is satisfied or not, that is, whether the length of each data is the length as a specified value or not. If not satisfied, the server sets that result2:=00 and shifts the process to 5. It is assumed here that data is properly padded as necessary. If satisfied, the server executes the following.
4. The server verifies whether r2i=PRF(sk,tss∥tsp∥IDi∥rhi∥rci) is satisfied or not. If correct, the server sets the lower two bits of result2:=rc. If not, the server sets that result2:=00. When result2 is 01, authentication success in the authentication target device is recorded. When result2 is 11, authentication failure due to reuse of authentication information is recorded. When result2 is 10, authentication failure due to mismatch of a pseudo random function value is recorded. When result2 is 00, a reception error (possibility of message falsification) is recorded.
5. The server sets that result:=result∪result2 and increments “i”.
6. The server outputs “result” as an authentication result and records it.

When there is a time restriction since transmission of authentication information from a server to an authentication proxy client until the server obtains an authentication result from the authentication proxy client, the server may execute the size check in the above operation 3 by comparing tss with present time in the server.

When there is a time restriction in transmission of an authentication result from the authentication proxy client to the server and the clock of the authentication proxy client is reliable, the check may be performed by additionally transmitting tsp2 from the authentication proxy lent to the server and comparing tsp2 and tss in the server.

In a manner similar to the case of FIG. 1, also in the protocol illustrated in FIG. 13, when rp is falsified, authentication in the authentication target device fails, so that it is fail-safe. Also in the case of falsification of rh, verification of an authentication result in the server fails, so that it is fail-safe. By authentication result verifying means in a server, even when an attacker falsifies the value of rc, the result does not pass the verification in the server. Also in the case where an attacker falsifies tsp, by the authentication result verifying means in the server, the result does not pass the verification in the server.

That is, even when any of rp, rc, and tsp is falsified, the attacker cannot obtain authentication success and verification pass on the authentication result of the authentication target device. When all or any of rp, rh, and rc are/is falsified, the server can detect the falsification. For the purpose of efficiently detecting authentication failure and verification failure by falsification, a hash value may be added to tsp.

Repetitive execution of the above-described operations (1), (2), and (3) is defined in a manner similar to that in the sequence illustrated in FIG. 2.

### Safety and Measure to be Satisfied by One-Time Offline Batch Authentication Protocol

It is obvious from the way how the protocol is configured that the offline authentication protocol according to the second embodiment has resistance to the attacks of the cases 1 to 5. As obvious from the way of the configuration, the offline authentication protocol according to the second embodiment has resistance to the attack of the case 6.

As described above, by executing the offline authentication protocol described in the second embodiment as described above, the following effects can be obtained.

1) On precondition that a server and an authentication target device hold a common key in advance, by delivering a storage medium in which information is written not via a network but between the server and the authentication proxy (authentication proxy client) and/or between the authentication proxy and the authentication target device, authentication of the authentication target device can be securely realized.
2) Coding/decoding process becomes unnecessary in the authentication result verification in the server.
3) Without accompanying signature issuance verification targeted at a communication path, in authentication result verification in a server, falsification can be detected not only by the result of authentication of an authentication target device, but also by transmission of an authentication result from the authentication target device to the server.
4) An attack by repetitive use of authentication information can be suppressed.

### Third Embodiment

In the protocols of the first and second embodiments, a situation that a clock is not mounted in an authentication target device is assumed, and a clock of an authentication proxy client is used in place of using a clock of the authentication target device.

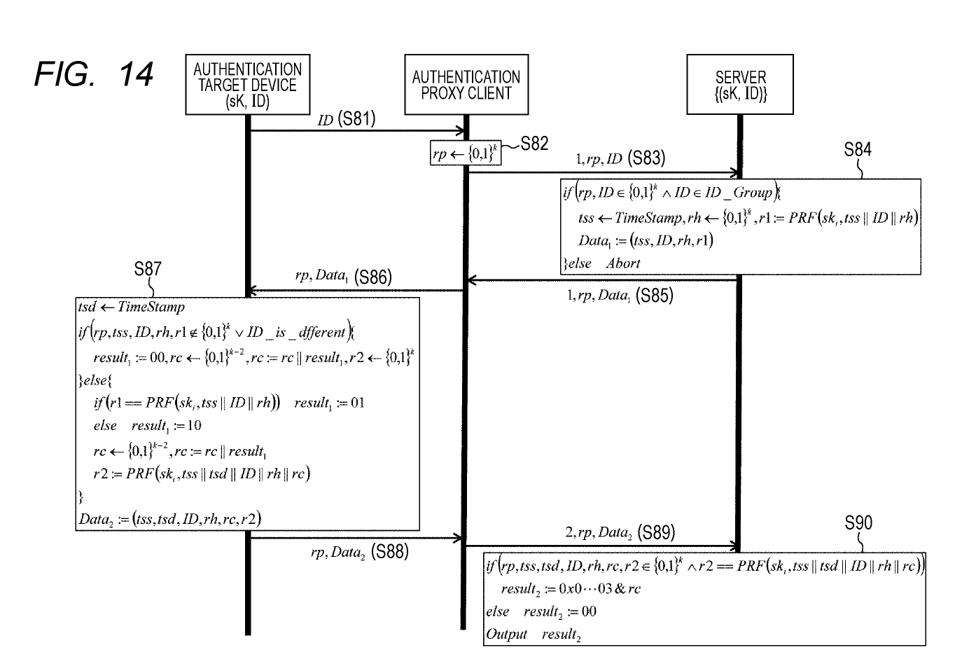

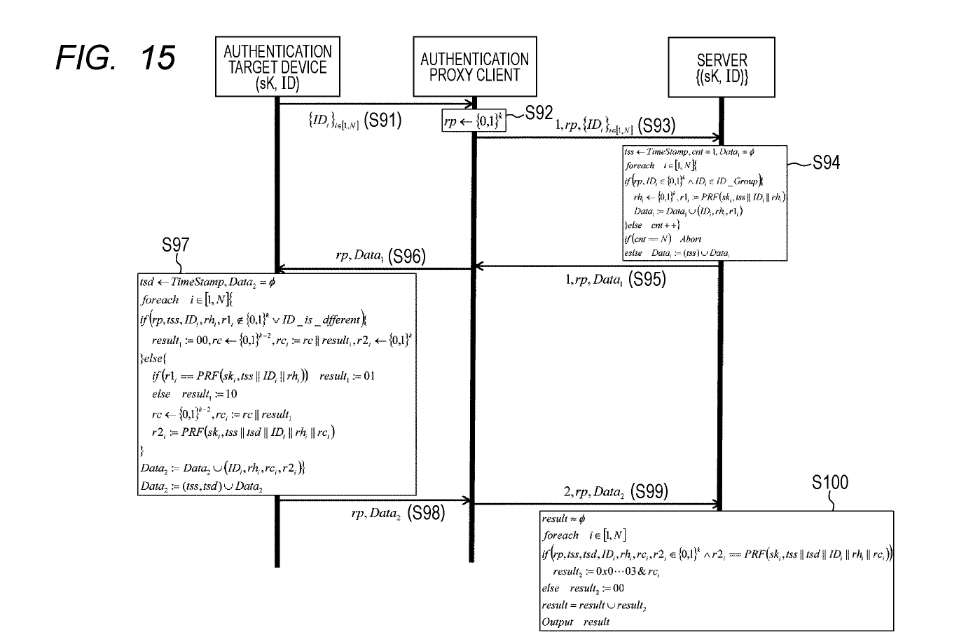

The value of the clock of the authentication proxy client can be protected by adding a hash value or the like. However, when a hash function is not used, falsification becomes possible. An attacker can realize failure in verification by falsification and failure in time restriction verification. FIGS. 14 and 15 illustrate protocols corresponding to FIGS. 1 and 12, respectively, in the case where a clock is mounted in an authentication target device.

### Offline Authentication Protocol with Terminal Clock

With reference to the sequence chart of FIG. 14, the operation of an offline authentication protocol in the case where an authentication target device has a clock will now be described. It is assumed that the following settings are made in advance as an initial setting of a common symmetric key for the authentication target device.

A security parameter is set as k and a server receives 1̂k. The server selects a symmetric key ski←{0,1}̂k for an authentication target device to which an authentication identifier IDi∈{0,1}̂k is assigned, and transmits (ski,IDi). The authentication target device stores (ski,IDi) into a nonvolatile memory and sends a set ID of the authentication identifier ID to an authentication proxy client.

The total number of authentication target devices is set to N and i∈[1,N] is set. For example, by performing those processes prior to shipment of authentication target devices, a unique key is set in each of the authentication target devices, and the key may be stored in the server. It is assumed that the authentication proxy client collects the ID of an authentication target device in advance.

### (1) Configuration in Server of Device Authentication Information

The authentication proxy client receives the ID from the authentication target device (S81), selects rp∈{0,1}̂k for session management (S82), and transmits (1,rp,ID) to the server (S83). The server receives (1,rp,ID) and executes the following procedure (S84).

1. The server verifies whether rp,ID∈{0,1}̂k is satisfied or not and whether ID∈ID is satisfied or not. If not, the server finishes the process. If satisfied, the server executes the following.
2. The server selects the present time as tss←TimeStamp.
3. The server selects a random number as rh←{0,1}̂k.
4. The server calculates r1:=PRF(sk,tss∥ID∥rh). The server sets that Data1:=(tss,ID,rh,r1) and transmits (1,rp,Data1) to the authentication proxy client (S85). The operator ‘∥’ expresses a bit conjunction.

### (2) Authentication and Result Collection in Authentication Target Device

The authentication proxy client transmits (rp,Data1) to the authentication target device (S86). The authentication target device receives (rp,Data1=(tss,ID,rh,r1)) and executes the following procedure (S87).

1. The authentication target device selects the present time as tsd←TimeStamp.
2. The authentication target device verifies whether rp,tss,ID,rh,r1∈{0,1}̂k is satisfied or not, that is, whether the length of each of data is length of a specified value or not, and checks whether the ID matches the ID of itself. It is assumed here that data is properly padded as necessary. If not satisfied, the authentication target device sets that result:=00,rc←{0,1}(k−2),rc:=rc∥result1,r2←{0,1}̂k. If satisfied, the authentication target device executes the following operations.
3. The authentication target device verifies whether r1=PRF(sk,tss∥ID∥rh) is satisfied or not. If satisfied, the authentication target device sets that result1:=01. If not, the authentication target device sets that result1:=10.
4. The authentication target device selects a random number as rc←{0,1}̂(k−2), and sets that rc:=rc∥result1∈{0,1}̂k.
5. The authentication target device obtains r2:=PRF(ski,tss∥tsp∥ID∥rh∥rc). The authentication target device sends (rp,Data2) as Data2:=(tss,tsd,ID,rh,rc,r2) to the authentication proxy client (S88).

When there is a time restriction in transmission of authentication information from the server to the authentication target device and tsd is reliable, by comparing tss and tsd at the time of the size check of 2, the authentication target device may perform the check.

### (3) Verification of Authentication Result in Server

The authentication proxy client transmits (2,rp, Data2) to the server (S89). The server receives (2,rp, Data2=(tss,tsd,ID,rh,rc,r2)) and verifies whether rp,tss,tsp,ID,rh,rc,r2∈{0,1}̂k is satisfied, that, the length of each of the data is the length as the specific value or not. If not satisfied, the server sets that result2:=00. It is assumed here that the data is properly padded as necessary. If satisfied, the server verifies whether r2=PRF(sk,tss∥tsd∥tsd∥ID∥rh∥rc is satisfied or not. If correct, the server sets the lower two bits of result2:=rc. If not, the server sets that result2:=00. The server outputs result2 as an authentication result, and records it (S90). When result2 is 01, authentication success in the authentication target device is recorded. When result is 10, authentication failure is recorded. When result2 is 00, a reception error (possibility of message falsification) is recorded.

When there is a time restriction since transmission of authentication information from a server to an authentication target device via an authentication proxy client until the server obtains an authentication result from the authentication proxy client, the server may perform the size check by comparing tss with present time in the server.

When there is a time restriction in transmission of an authentication result from the authentication target device to the server and the clock of the authentication target device is reliable, the server may perform the check by comparing tsd and tss.

In the protocol, when rp is falsified, a corresponding session becomes non-existing. Even a corresponding session exists, authentication in an authentication target device is executed in a different session and fails, so that it is fail-safe. Also in the case of falsification of rh, verification of an authentication result in a server fails, so that it is fail-safe. By authentication result verifying means in a server, even when an attacker falsifies the value of rc, the result does not pass the verification in the server. Also in the case where tsd is falsified, by the authentication result verifying means in the server, the result does not pass the verification in the server.

That is, even when any of rp, rc, and tsd is falsified, the attacker cannot obtain authentication success and verification pass on the authentication result of the authentication target device. When all or any of rp, rh, rc and tsd are/is falsified, for example, the server can detect the falsification. Therefore, it is unnecessary to add a hash value to tsd. One-time use of authentication information may be realized by the monotonic counter introducing method described in the first embodiment.

Repetitive execution of the above-described operations (1), (2), and (3) is defined in a manner similar to that in the sequence illustrated in FIG. 2.

### Safety and Measure to be Satisfied by Offline Authentication Protocol with Terminal Clock

As obvious from the way of the configuration of the offline authentication protocol of FIG. 14, the offline authentication protocol in FIG. 14 has resistance to the attacks of the cases 1 to 5.

### Offline Batch Authentication Protocol with Terminal Clock

With reference to the sequence chart of FIG. 15, the operations of an offline authentication protocol which is made as a batch process in the case where an authentication target device has a clock will be described. It is assumed that initial settings of a common symmetric key for all of authentication target devices are made in advance in a manner similar to the first embodiment

A security parameter is set as k and a server receives 1̂k. The server selects a symmetric key ski←{0,1}̂k for an authentication target device to which an authentication identifier Idi∈{0,1}̂k is assigned, and transmits (ski,IDi). The authentication target device stores (ski,IDi) into a nonvolatile memory and sends a set ID of the authentication identifier IDi to an authentication proxy client.

The total number of authentication target devices is set to N and i∈[1,N] is set. For example, by performing those processes prior to shipment of authentication target devices, a unique key is set in each of the authentication target devices, and the key may be stored in the server. It is assumed that the authentication proxy client collects the IDs of authentication target devices in advance.

### (1) Configuration in Server of Device Authentication Information

An authentication proxy client receives {IDi; i∈[1,N]} from an authentication target device (S91), selects rp∈{0,1}̂k for session management (S92), and transmits 1,rp,{IDi; i∈[1,N]}) together with the set of IDs {IDi; i∈[1,N]} of the authentication target device group to a server (S93). The transmission may be realized not via a network but by delivering a storage medium in which information is written.

The server receives (1,rp,{IDi; i∈[1, N]}) and executes the following procedure (S94).

1. The server selects the present time as tss TimeStamp and sets that cnt:=1 and Data1:=Φ (empty set).
2. The server executes the following operations 3, 4, 5, and 6 for each of i∈[1, N].
3. The server verifies whether rp,Idi∈{0,1}̂k is satisfied or not and whether IDi∈ID is satisfied or not. If not, the server increments cnt and shifts the process to 6. If satisfied, the server executes the following.
4. The server selects a random number as rhi←{0.1}̂k.
5. The server calculates r1i:=PRF(ski,tss∥IDi∥rhi)
6. The server sets that Data1:=(IDi,rhi,r1i)∪Data1 and increments “i”. The operator ‘∥’ expresses a bit conjunction.
7. If cnt==N, the server finishes the process. If not, the server sets that Data1:=(tss)∪Data1, and transmits (1,rp, Data) to the authentication proxy client (S95). The transmission may not be performed via a network but may be realized by delivering a storage medium in which information is written.

### (2) Authentication and Result Collection in Authentication Target Device

The authentication proxy client transmits (rp,tsp,Data1) to the authentication target device (S96). The authentication target device receives (rp,tsp,Data1={(tss,IDi,rhi,r1i); i∈[1,N]}) and executes the following procedure (S97). The reception may be realized not via a network but by receiving a storage medium in which information is written.

1. The authentication target device selects the present time information tsd←TimeStamp.
2. Data2:=Φ (empty set)
3. For each i∈[1,N], the authentication target device executes the following operations 4, 5, 6, 7 and 8.
4. The authentication target device verifies whether rp,tsp,tss,IDi,rhi,r1i∈{0,1}̂k is satisfied or not, that is, whether the length of each data becomes the length as a specified value or not and checks whether IDi matches that of itself. It is assumed that data is properly padded as necessary. If not satisfied, the authentication target device sets that result1:=00, rc←{0,1}̂(k−2), rci:=rc∥result1,r2i←{0,1}̂k, and shifts the process to 7. If satisfied, the authentication target device executes the following operations.
5. The authentication target device verifies whether r1i=PRF(ski,tss∥IDi∥rhi) is satisfied or not. If satisfied, the authentication target device sets that result1:=01 and, if not, sets that result1:=10.
6. The authentication target device selects a random number as rc←{0,1}̂(k−2), and sets that rci:=rc∥result1∈{0,1}̂k.
7. The authentication target device obtains r2i:=PRE(ski,tss∥tsp∥IDi∥rhi∥rci).
8. The authentication target device sets that Data2:=(tss,IDi,rhi,rci,r2)∪Data2, and increments “i”.
9. The authentication target device transmits (rp,Data2) as Data2:=(tss,tsd)∪Data2 to the authentication proxy client (S98). The transmission may be realized not via a network but by transmitting a storage medium in which information is written. When there is a time restriction in transmission from the server to the authentication target device and tsd is reliable, the authentication target device may perform the size check in the above-described process 4 by comparing tss and tsd.

### (3) Verification of Authentication Result in Server

The authentication proxy client transmits (2,rp,Data2) to the server (S99). The server receives (2,rp, Data2={(tss,tsd,IDi,rhi,rci,r2i); i∈[1,N]}) and executes the following procedure (S100).

1. result:=Φ
2. The server executes the following operations 3, 4, and 5 for each i∈[1,N].
3. The server verifies whether rp,tss,tsd,IDi,rhi,rci,r2i∈{0,1}̂k is satisfied or not, that is, whether the length of each data is the length as a specified value or not. If not satisfied, the server sets that result2:=00 and shifts the process to 5. It is assumed here that data is properly padded as necessary. If satisfied, the server executes the following.
4. The server verifies whether r2i=PRF(sk,tss∥tsd∥IDi∥rhi∥rci) is satisfied or not. If correct, the server sets the lower two bits of result2:=rc. If not, the server sets that result2:=00. When result2 is 01, authentication success in the authentication target device is recorded. When result2 is 10, authentication failure is recorded. When result2 is 00, a reception error (possibility of message falsification) is recorded.
5. The server sets that result:=result∪result2 and increments “i”.
6. The server outputs “result” as an authentication result and records it.

When there is a time restriction since transmission of authentication information from a server to an authentication proxy client until the server obtains an authentication result from the authentication proxy client, the server may execute the size check by comparing tss with present time in the server.

When there is a time restriction in transmission of an authentication result from the authentication target device to the server and the clock of the authentication target device is reliable, the server may perform the check by comparing tsd and tss.

In the protocol, when rp is falsified, a corresponding session becomes non-existing. Even a corresponding session exists, authentication in an authentication target device is executed in a different session and fails, so that it is fail-safe. Also in the case of falsification of rh, verification of an authentication result in a server fails, so that it is fail-safe.

By authentication result verifying means in a server, even when an attacker falsifies the value of rc, the result does not pass the verification in the server. Also in the case where tsd is falsified, by the authentication result verifying means in the server, the result does not pass the verification in the server.

That is, when any of rp, rc, and tsd is falsified, the attacker cannot obtain authentication success and verification pass on the authentication result of the authentication target device. When all or any of rp, rh, rc and tsd are/is falsified, the falsification can be detected. Therefore, it is unnecessary to add a hash value to tsd.

One-time use of authentication information may be realized by the monotonic counter introducing method described in the second embodiment. Repetitive execution of the above-described operations (1), (2), and (3) is defined in a mariner similar to that in the sequence illustrated in FIG. 2.

### Safety and Measure to be Satisfied by Offline Batch Authentication Protocol with Terminal Clock

As obvious from the way of the configuration of the offline authentication protocol of the third embodiment, the offline authentication protocol of the third embodiment has resistance to the attacks of the cases 1 to 5.

### One-Time Offline Authentication Protocol with Terminal Clock

In a manner similar to the configuration method described in the first embodiment, a protocol can be defined.

### Safety and Measure to be Satisfied by One-time Offline Authentication Protocol with Terminal Clock

It is obvious from the way how the protocol is configured that there is resistance to the attacks of the cases 1 to 5. As obvious from the way of the configuration, there is resistance to the attack of the case 6.

### One-Time Offline Batch Authentication Protocol with Terminal Clock

In a manner similar to the configuration method described in the first embodiment, a protocol can be defined.

### Safety and Measure to be Satisfied by One-Time Offline Batch Authentication Protocol with Terminal Clock

It is obvious from the way how the protocol is configured that there is resistance to the attacks of the cases 1 to 5. As obvious from the way of the configuration, there is resistance to the attack of the case 6.

### Fourth Embodiment

There is a method such that a memory space is divided into A and B, A can be accessed from B but an access from A to B is allowed only via an API (Application Programming Interface) constructed in B, thereby protecting programs and resources in B. Actual product development is made in a state where (an API for erasing the resources in B for the purpose of debugging or the like and an API which enables execution of a program which can become a security risk are added.

When the API added for the purpose of debugging is eliminated at the time of product shipment, protection of the programs and resources in B is realized. However, products are often shipped without eliminating the API added for the purpose of debugging for reasons such as a measure to a trouble after shipment.

As a measure to this problem, a method is considered such that a pre-shared key with an authentication server is securely disposed in B and, at the time of executing the API in B from A, whether an execute authority is given or not is authenticated. However, the method has problems. Communication with the server is necessary each time the API is executed, so that execution time becomes longer and power consumption increases due to the communication. Further, when there is no communication environment, the API cannot be executed, so that convenience largely decreases.

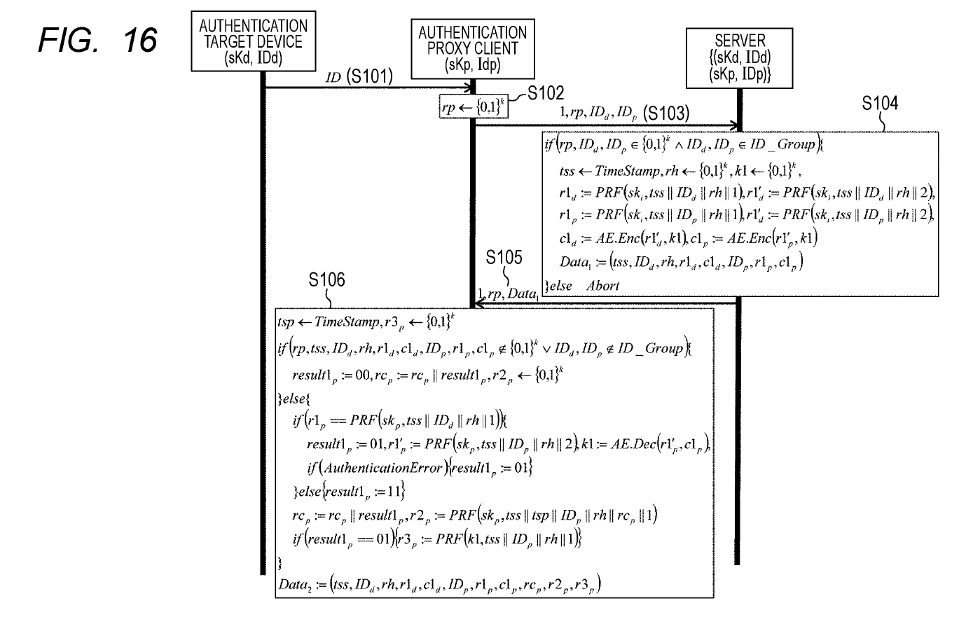

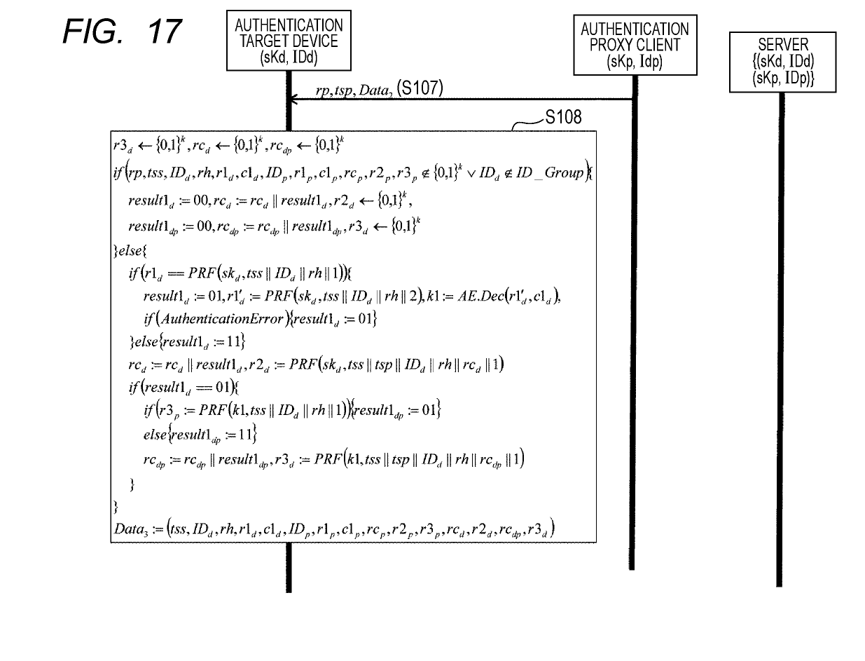

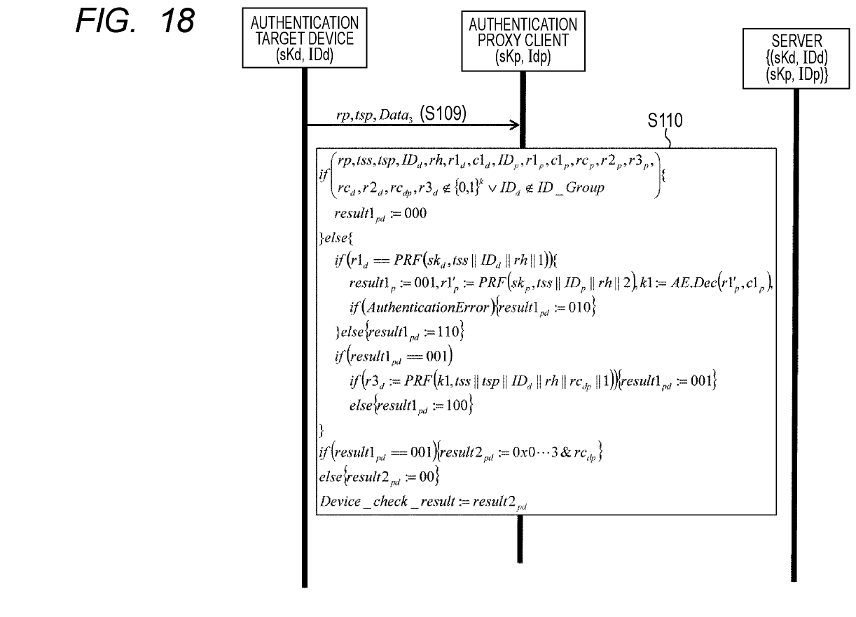

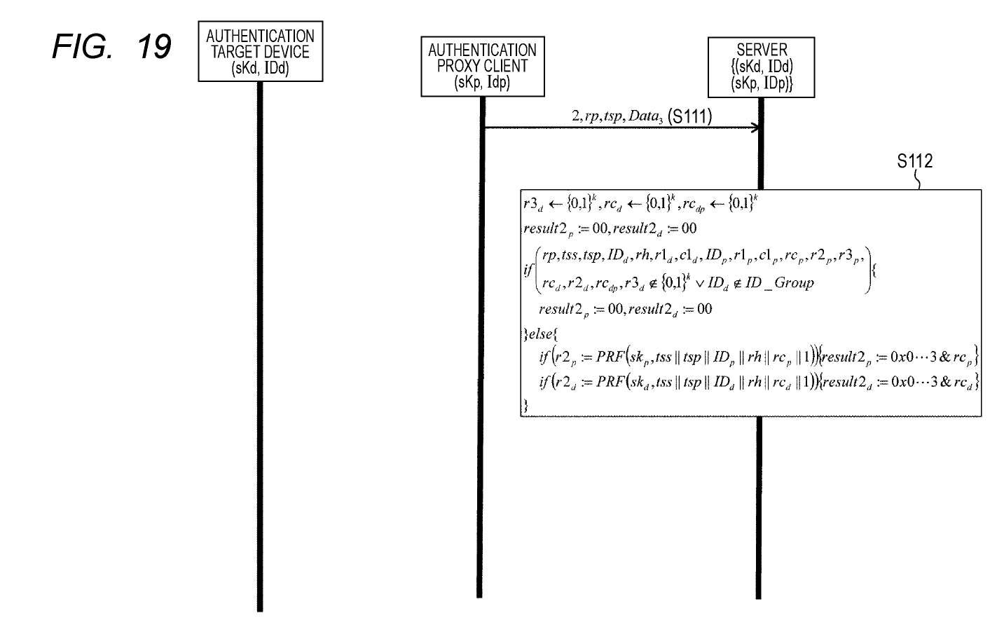

By using the authentication methods described in the first to third embodiments in API execution, such problems are solved and API execution can be realized by which aimed protection of resources and programs can be achieved only by an overhead necessary for the authenticating process in a terminal even when there is no communication environment. Hereinafter, with reference to the sequence charts of FIGS. 16 to 19, operation of extending the authentication methods described in the first to fourth embodiments to authentication accompanying key delivery will be described.

### (1) Configuration in Server of Device Authentication Information

An authentication proxy client receives IDd from an authentication target device (S101), selects rp∈{0,1}̂k for session management (S102), and transmits (1,rp,IDd,IDp) to a server (S103). IDd is an ID assigned to the authentication target device IDp is an ID assigned to the authentication proxy client. The server receives (1,rp,IDd,IDp) and executes the following procedure (S104).

1. The server verifies whether rp,IDd,IDp∈{0,1}̂k is satisfied or not and whether ID∈ID is satisfied or not. If no, the server finishes the process. If satisfied, the server executes the following.
2. The server selects the present time as tss←TimeStamp.
3. The server selects a random number as rh←{0,1}̂k and k1←{0,1}̂k.
4. The server calculates r1dd:=PRF(ski,tss∥IDd∥rh∥1), r1′d:=PRF(ski,tss∥IDd∥rh∥2), r1p:=PRF(ski,tss∥IDp∥rh∥1), r1′p:=PRF(ski,tss∥IDp∥rh∥2), c1d:=AE.Enc(r1′d,
k1), c1p:=AE.Enc(r1′p, k1). The server transmits (1,rp,Data1) as Data1:=(tss,IDd,rh,
r1d,c1d,IDp,r1p,c1p) to the authentication proxy client (S105). PRF denotes a Pseudo Random Function, AE.Enc denotes encryption by an authenticated Encryption method, and the operator ‘∥’ expresses a bit conjunction.

### (2) Authentication and Result Collection in Authentication Proxy Client.

The authentication proxy client receives (rp,Data1=rp,tss,IDd,rh,r1,c1d,IDp,r1p,c1p) and executes the following procedure (S106)

1. The authentication proxy client selects the present time as tsp←TimeStamp and selects a random number as r3p←{0,1}̂k.
2. The authentication proxy client verifies whether rp,tss,IDd,rh,r1d,c1d,IDp,r1p,c1p∈{0,1}̂k is satisfied, that is, whether the length of each data is length as a specified value and checks whether IDd and IDp match that of itself. It is assumed here that data is properly padded as necessary. If not satisfied, the authentication proxy client sets that result1p:=00, rcp:=rcp∥result1p,r2p←{0,1}̂k. If satisfied, the authentication proxy client executes the following operations.
3. The authentication proxy client verifies whether r1p=PRF(skp,tss∥IDp∥rh∥1) is satisfied or not. If satisfied, the authentication proxy client sets that result1p:=01,r1′p:=PRF(skp,tss∥IDp∥rh∥2), k1:=AE.Dec(r1′p, c1p). If not satisfied, the authentication proxy client sets that result1p:=11 .AE.Dec expresses decoding in the authenticated encryption method.
4. The authentication proxy client sets that rcp:=rc∥result1p and obtains r2p:=PRF(skp,tss∥IDp∥rh∥rcp∥1).
5. When result1p:=01, the authentication proxy client obtains r3p:=PRF(k1,tss∥IDp∥rh∥1). The authentication proxy client sets that Data2:=(tss,IDd,rh,r1d,c1d,IDp,r1p,c1p,rcp,r2p,r3p) and transmits (rp,tsp,Data2) to the authentication target device (S107).

### (3) Authentication and Result Collection in Authentication Target Device

The authentication target device receives (rp,tsp,Data2=rp, tss, IDd, rh, r1d, c1d, IDp, r1p, c1p, rcp, r2p, r3p) and executes the following procedure (S108).

1. The authentication target device selects a random number as r3d←{0,1}̂k, rcd←{0,1}̂k, rcdp←{0,1}̂k.
2. The authentication target device verifies whether rp, tss, IDd, rh, r1d, c1d, IDp, r1p, c1p, rcp, r2p, r3p∈{0,1}̂k is satisfied or not, that is, whether the length of each data is length as a specific value or not and checks whether IDd matches that of itself. It is assumed here that data is properly padded as necessary. If not satisfied, the authentication target device sets that result1d:=00,rcd:=rcd∥result1d,r2d←{0,1}̂k, result1dp:=00,rcdp:=rcdp∥result1dp,r3d←{0,1}̂k. If satisfied, the authentication target device executes the following operations.
3. The authentication target device verifies whether r1d=PRF(skd,tss∥IDd∥rh∥1) is satisfied or not. If satisfied, the authentication target device sets that result1d:=01,r1′d:=PRE(skd,tss∥IDd∥rh∥2), k1:=AE.Dec(r1′d,c1d). If not satisfied, the authentication target device sets that result1d:=11.
4. The authentication target device sets that rcd:=rcd∥result1d, and obtains r2d:=PRF(skd,tss∥IDd∥rh∥IDd∥rh∥1).
5. The authentication target device sets that result1dp:=01 when result1d:=01 and r3d:=PRF(k1,tss∥IDd∥rh∥1) is satisfied and, when not satisfied, sets that result1dp:=11.
6. The authentication target device sets that rcdp:=rcdp∥result1dp, and obtains r3d:=PRE(k1,tss∥tsp∥IDd∥rh∥rcdp∥1). The authentication target device transmits (rp,tsp,Data3) as Data:=(tss, IDd, rh, r1d, c1d, IDp, r1p, c1p, r
cp, r2p, r3p, rcd, r2d, rcdp, r3d) to the authentication proxy client (S109).

### (4) Verification of Authentication Result in Authentication Proxy Client

The authentication proxy client receives (rp,tsp,Data3=(tss, IDd, rh, r1d, c1d, IDp, r1p, c1p, rcp, r2p, r3p, rcd, r2d, rcdp, r3d)) and executes the following procedure (S110).

1. The authentication proxy client verifies whether tss, IDd, rh, r1d, c1d, IDp, r1p, c1p, rcp, r2p, r3p, rcd, r2d, rcdp, r3d∈{0,1}̂k is satisfied or not, that is, whether the length of each of data is length as a specified value or not and checks whether IDd matches that of itself. It is assumed that data is properly padded as necessary. If not satisfied, the authentication proxy client sets that result1pd:=000. If satisfied, the authentication proxy client verifies whether r1d=PRF(skd,tss∥IDp∥rh∥1) is satisfied or not. If correct, the authentication proxy client sets that result1p:=001, r1′p:=PRF(skp,tss∥IDp∥rh∥2), k1:=AE,Dec (r1′p, c1p) and, if not, sets that result1pd:=110.
2. When result1pd:=001, the authentication proxy client verifies whether r3d=PRF(k1,tss∥tsp∥IDd∥rh∥rcdp∥1) is satisfied or not. The authentication proxy client sets that result1pd:=001 when satisfied and, when not satisfied, sets that result:=100.
3. The authentication proxy client sets lower two bits of result2pd:=rcdp when result1pd:=001 and, if not, sets that result2pd:=00. The authentication proxy client outputs result2 as an authentication result and records it. The authentication proxy client transmits (rp,tsp,Data3) as Data3:=(tss, IDd, rh, r1d, c1d, IDp, r1p, c1p, rcp, r2p, r3p, rcd, r2d, rcdp, r3d) to the server (S111).

### (5) Verification of Authentication Result in Server

The authentication proxy client receives (rp,tsp,Data3=(tss, IDd, rh, r1dd, c1d, IDp, r1p, c1p, rcp, r2p, r3p, rcd, r2d, rcdp, r3d)) and executes the following procedure (S112).

1. The authentication proxy client selects a random number as r3d←{0,1}̂k, rcd←{0,1}̂k, rcdp←{0,1}̂k.
2. The authentication proxy client verifies whether tss, IDd, rh, r1d, c1d, IDp, r1p c1p, rcp, r2p, r3p, rcd, r2d, rcdp, r3d∈{0,1}̂k or not, that is, whether the length of each of data is length as a specified value or not and checks whether IDd matches that of itself. It is assumed that data is properly padded as necessary. If not satisfied, the authentication proxy client sets that result2p:=00 and result2d:=00. If satisfied, the authentication proxy client verifies whether r2p=PRF(skp,tss∥tsp∥IDp∥rh∥rcp∥1), r2d=PRF(skd,tss∥tsp∥IDd∥rh∥rcd∥1) is satisfied or not. If correct, the authentication proxy client sets the lower two bits of result2p:=rcp and lower two bits of result2d:=rcd.

As described above, by using the protocol according to the third embodiment, even there is no communication environment, API execution which can achieve aimed protection of resources and programs only by the overhead necessary for the authenticating process in a terminal can be realized.

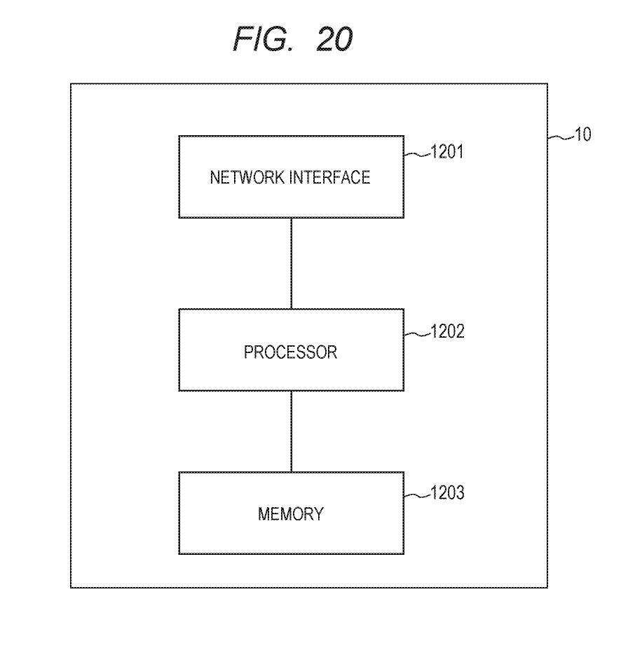

Hereinbelow, a configuration example of an authentication target device, an authentication proxy client, and a server described in the foregoing first to fourth embodiments will be described with reference to FIG. 20. FIG. 20 illustrates a computer device 10 used in an authentication target device, an authentication proxy client, and a server. The computer device 10 includes a network interface 1201, a processor 1202, and a memory 1203. The network interface 1201 is used for communicating with another network node device as a component of the communication system. The network interface 1201 may include, for example a network interface card (NIC) conformed with the IEEE802.3 series.

The processor 1202 reads software (computer program) from the memory 1203 and executes it, thereby performing processes of the processes of the authentication target device, the authentication proxy client, and the server described with reference to the sequence charts and the flowcharts in the foregoing embodiments. The processor 1202 may be, for example, a microprocessor, an MPU (Micro Processing Unit), or a CPU (Central Processing Unit). The processor 1202 may include a plurality of processors.

The memory 1203 is configured by a combination of a volatile memory and a nonvolatile memory. The memory 1203 may include a storage disposed apart from the processor 1202. In this case, the processor 1202 may access the memory 1203 via a not-illustrated I/O interface.

In the example of FIG. 20, the memory 1203 is used for storing a group of software modules. The processor 1202 reads the software module group from the memory 1203 and executes it, thereby performing the processes of the authentication target device, the authentication proxy client, and the server described in the above embodiments.

As described with reference to FIG. 20, each of the processors of the authentication target device, the authentication proxy client, and the server executes one or plural programs including an instruction group for making a computer execute the algorithm described with reference to the drawings.

Elements illustrated in the drawings as function blocks performing various processes can be configured by a CPU, a memory, and other circuits as hardware and realized by a program loaded to the memory as software. Therefore, a person skilled in the art understands that those function blocks can be realized in various forms by only hardware, only software, or combination of hardware and software and are not limited to any of them. In the drawings, the same reference numeral is assigned to the same component and repetitive description is omitted as necessary.

The above-described program is stored by using non-transitory computer readable media of various types and can be supplied to a computer. The non-transitory computer readable media include

tangible storage media of various types. Examples of the non-transitory computer readable media include magnetic recording media (for example, flexible disk, magnetic tape, and hard disk drive), magnet-optic recording media (for example, magnet-optic disk), CD-ROM (Read Only Memory), CD-R, CD-R/W, and semiconductor memories (for example, mask ROM, PROM (Programmable ROM), EPROM (Erasable PROM), flash ROM, and RAM (Random Access Memory)). The program may be supplied to a computer by any of transitory computer readable media of various types. Examples of the transitory computer readable media include an electric signal, an optical signal, and an electromagnetic wave. The transitory computer readable medium can supply a program to a computer via a wired communication path such as an electric wire or an optical fiber or a wireless communication path.

Although the present invention achieved by the inventors herein has been concretely described above on the basis of the embodiments, obviously, the present invention is not limited to the foregoing embodiments but can be variously changed without departing from the gist.

What is claimed is:

1. An authentication method comprising:
allowing a server to generate first authentication information configured by a value generated by using a pseudo ransom function using an identifier of an authentication target device and a common key as arguments and to transmit the first authentication information to the authentication target device via an authentication proxy client; and
allowing the authentication target device to check validity of the first authentication information by comparing the value generated by using the pseudo random function using the identifier and the common key as arguments with the first authentication information, and after checking the validity of the first authentication information, allowing the authentication target device to generate second authentication information configured by a value generated by using a pseudo random function using the identifier of the authentication target device, the common key, and a check result of the first authentication information as arguments, and to transmit the second authentication information to the authentication proxy client.

2. The authentication method according to claim 1,
wherein the authentication proxy client transmits the second authentication information to the server, and
wherein the server checks validity of the second authentication information.

3. The authentication method according to claim 1, wherein the server generates first time information regarding time when the first authentication information is generated, and generates the first authentication information configured by a value generated by using a pseudo random function using the identifier of the authentication target device, the common key, and the first time information as arguments.

4. The authentication method according to claim 1, wherein the authentication target device generates the second authentication information configured by a value generated by using a pseudo random function using second time information regarding time when the authentication proxy client receives the first authentication information, the identifier of the authentication target device, the common key, and a check result of the first authentication information as arguments.

5. The authentication method according to claim 3,
wherein the authentication target device determines whether length of data of the first authentication information is as a specified value or not as validity of the first authentication information, and
wherein the authentication proxy client transmits second authentication information including a result of determination whether the length of the data of the first authentication information is as a specified value or not to the server

6. The authentication method according to claim 3, wherein the authentication target device checks whether the difference between the first time information and second time information regarding time when the authentication proxy client receives the first authentication information satisfies a predetermined time restriction or not.

7. The authentication method according to claim 4, wherein the server checks whether the difference between the second time information and third time information regarding time when the authentication proxy client receives the second authentication information satisfies a predetermined time restriction or not.

8. The authentication method according to claim 1, wherein the server uses a monotonic counter limiting the number of times of use of the first authentication information.

9. The authentication method according to claim 8, wherein the server generates the first authentication information by using a value indicated by the monotonic counter.

10. The authentication method according to claim 1,
wherein the authentication proxy client transmits identifiers of a plurality of authentication target devices to the server, and
wherein the server generates the first authentication information regarding each of the authentication target devices.

11. The authentication method according to claim 1, wherein the authentication target device generates the second authentication information configured by a value generated by using a pseudo random function using fourth time information regarding time when the first authentication information is received, the identifier of the authentication target device, the common key, and a check result of the first authentication information as arguments.

12. The authentication method according to claim 1,
wherein the authentication proxy client transmits an identifier of itself together with the identifier of the authentication target device to the server, and
wherein the server generates third authentication information configured by a value generated by using a pseudo random function using the identifier of the authentication proxy client and the common key as arguments together with the first authentication information.

13. The authentication method according to claim 1,
wherein the authentication proxy client transmits the identifier of an authentication device collected and a session identifier for identifying a communication corresponding relation to a server, and
wherein the server checks validity of the identifier of the authentication target device and the session identifier.

14. An authentication system comprising
an authentication target device,
a server selecting a common key for the authentication target device, and
an authentication proxy client relaying communication between the authentication target device and the server,
wherein the server generates first authentication information configured by a value generated by using a pseudo random function using an identifier of the authentication target device and the common key as arguments and transmits the first authentication information to the authentication target device via the authentication proxy client, and
wherein the authentication target device checks validity of the first authentication information by comparing the value generated by using the pseudo random function using the identifier and the common key as arguments and the first authentication information, after checking the validity of the first authentication information, generates second authentication information configured by a value generated by using a pseudo random function using the identifier of the authentication target device, the common key, and a result of the check of the first authentication information as arguments, and transmits the second authentication information to the authentication proxy client.
